(19) United States
(12) Patent Application Publication
(10) Pub. No.: US 2025/0343611 A1
(43) Pub. Date: Nov. 6, 2025

(54) ELECTRONIC DEVICE AND METHOD FOR RECEIVING SIGNAL IN WIRELESS COMMUNICATION SYSTEM

(71) Applicant: Samsung Electronics Co., Ltd., Suwon-si (KR)

(72) Inventors: Soongyoon CHOI, Suwon-si (KR); Ikbeom LEE, Suwon-si (KR); Joohyun LEE, Suwon-si (KR)

(21) Appl. No.: 19/273,674

(22) Filed: Jul. 18, 2025

Related U.S. Application Data
(63) Continuation of application No. PCT/KR2024/000066, filed on Jan. 2, 2024.

(30) Foreign Application Priority Data
Jan. 20, 2023 (KR) 10-2023-0009098
Feb. 20, 2023 (KR) 10-2023-0022491

(51) Int. Cl. H04B 17/309; H04L 5/00

(52) U.S. Cl. CPC H04B 17/346; H04L 5/0044; H04L 5/0051

(57) ABSTRACT

A method performed by a device of a base station may comprise: obtaining an uplink signal of a data symbol; obtaining a first noise-interference covariance matrix for reference signals; obtaining a second noise-interference covariance matrix for a reference signal related to the data symbol among the reference signals; based on a first interference factor of the first noise-interference covariance matrix, identifying whether a second interference factor of the second noise-interference covariance matrix is within an abnormal range; based on the second interference factor of the second noise-interference covariance matrix being within the abnormal range, obtaining data corresponding to the uplink signal based on the second noise-interference covariance matrix; and based on the second interference factor of the second noise-interference covariance matrix not being within the abnormal range, obtaining data corresponding to the uplink signal based on the first noise-interference covariance matrix.

### CROSS-REFERENCE TO RELATED APPLICATIONS

This application is a continuation of International Application No. PCT/KR2024/000066 designating the United States, filed on Jan. 2, 2024, in the Korean Intellectual Property Receiving Office and claiming priority to Korean Patent Application Nos. 10-2023-0009098, filed on Jan. 20, 2023, and 10-2023-0022491, filed on Feb. 20, 2023, in the Korean Intellectual Property Office, the disclosures of each of which are incorporated by reference herein in their entireties.

### BACKGROUND

### Field

The disclosure relates to an electronic device and a method for receiving a signal in a wireless communication system.

### Description of Related Art

To improve transmission and reception performance of a signal, a multiple-input multiple-output (MIMO) technique is used. To process a received signal in a wireless communication system using the MIMO technique, channel estimation may be performed. By performing channel estimation in consideration of interference or noise on a wireless channel, a receiver may obtain a transmission signal.

The above-described information may be provided as related art for the purpose of helping the understanding of the present disclosure. No assertion or determination is raised as to whether any of the above-described content may be applied as prior art associated with the present disclosure.

### SUMMARY

According to example embodiments, a method performed by a device of a base station is provided. The method may comprise: obtaining an uplink signal of a data symbol; obtaining a first noise-and-interference covariance matrix for reference signals; obtaining a second noise-and-interference covariance matrix for a reference signal associated with the data symbol among the reference signals; identifying whether a second interference factor of the second noise-and-interference covariance matrix is within an abnormal range based on a first interference factor of the first noise-and-interference covariance matrix; based on the second interference factor of the second noise-and-interference covariance matrix being within the abnormal range, obtaining data corresponding to the uplink signal based on the second noise-and-interference covariance matrix; and based on the second interference factor of the second noise-and-interference covariance matrix not being within the abnormal range, obtaining the data corresponding to the uplink signal based on the first noise-and-interference covariance matrix.

According to example embodiments, a device of a base station is provided. The device may comprise: memory, at least one transceiver, and at least one processor, comprising processing circuitry, wherein at least one processor, individually and/or collectively, may be configured to cause the device to: obtain an uplink signal of a data symbol; obtain a first noise-and-interference covariance matrix for reference signals; obtain a second noise-and-interference covariance matrix for a reference signal associated with the data symbol among the reference signals; identify whether a second interference factor of the second noise-and-interference covariance matrix is within an abnormal range based on a first interference factor of the first noise-and-interference covariance matrix; obtain data corresponding to the uplink signal based on the second noise-and-interference covariance matrix based on the second interference factor of the second noise-and-interference covariance matrix being within the abnormal range; and obtain the data corresponding to the uplink signal based on the first noise-and-interference covariance matrix based on the second interference factor of the second noise-and-interference covariance matrix not being within the abnormal range.

According to example embodiments, a digital unit (DU) is provided in a wireless communication system. The DU may comprise: memory storing instructions, at least one transceiver, and at least one processor, comprising processing circuitry, wherein at least one processor, individually and/or collectively, may be configured to execute the instructions and to cause the DU to: obtain an uplink signal of a data symbol, obtain a first noise-and-interference covariance matrix for reference signals, obtain a second noise-and-interference covariance matrix for a reference signal associated with the data symbol among the reference signals, identify whether a second interference factor of the second noise-and-interference covariance matrix is within an abnormal range based on a first interference factor of the first noise-and-interference covariance matrix, obtain data corresponding to the uplink signal based on the second noise-and-interference covariance matrix based on the second interference factor of the second noise-and-interference covariance matrix being within the abnormal range, and obtain the data corresponding to the uplink signal based on the first noise-and-interference covariance matrix based on the second interference factor of the second noise-and-interference covariance matrix not being within the abnormal range.

According to example embodiments, a radio unit (RU) is provided in a wireless communication system. The RU may comprise: memory storing instructions, at least one transceiver, and at least one processor, comprising processing circuitry, wherein at least one processor, individually and/or collectively, may be configured to execute the instructions and to cause the RU to: obtain an uplink signal of a data symbol, obtain a first noise-and-interference covariance matrix for reference signals, obtain a second noise-and-interference covariance matrix for a reference signal associated with the data symbol among the reference signals, identify whether a second interference factor of the second noise-and-interference covariance matrix is within an abnormal range based on a first interference factor of the first noise-and-interference covariance matrix, obtain data corresponding to the uplink signal based on the second noise-and-interference covariance matrix based on the second interference factor of the second noise-and-interference covariance matrix being within the abnormal range, and obtain the data corresponding to the uplink signal based on the first noise-and-interference covariance matrix based on the second interference factor of the second noise-and-interference covariance matrix not being within the abnormal range.

According to example embodiments, a non-transitory computer-readable storage medium is provided. The non-transitory computer readable storage medium may store instructions that, when executed by at least one processor, comprising processing circuitry, individually and/or collectively, of a device, cause the device to perform operations including: obtaining an uplink signal of a data symbol, obtaining a first noise-and-interference covariance matrix for reference signals, obtaining a second noise-and-interference covariance matrix for a reference signal associated with the data symbol among the reference signals, identifying whether a second interference factor of the second noise-and-interference covariance matrix is within an abnormal range based on a first interference factor of the first noise-and-interference covariance matrix, obtaining data corresponding to the uplink signal based on the second noise-and-interference covariance matrix based on the second interference factor of the second noise-and-interference covariance matrix being within the abnormal range, and obtaining the data corresponding to the uplink signal based on the first noise-and-interference covariance matrix based on the second interference factor of the second noise-and-interference covariance matrix not being within the abnormal range.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example wireless communication system according to various embodiments;

FIG. 2 is a block diagram illustrating an example configuration of a fronthaul interface according to various embodiments;

FIG. 3 is a diagram illustrating an example of a resource structure in a time domain and in a frequency domain according to various embodiments;

FIG. 4 is a diagram illustrating an example of channels in a communication standard according to various embodiments;

FIG. 5 is a diagram illustrating an example of interference for a physical uplink shared channel (PUSCH) transmission according to various embodiments;

FIGS. 6A and 6B are graphs illustrating examples of an interference factor for identifying interference according to various embodiments;

FIGS. 7A and 7B are diagrams illustrating an example of functional blocks for adaptively selecting a noise-and-interference covariance matrix according to various embodiments;

FIG. 8 is a diagram illustrating an example of an average operation of a noise-and-interference covariance matrix according to various embodiments;

FIG. 9A is a flowchart illustrating an example operation of a device of a base station for adaptively selecting a noise-and-interference covariance matrix according to various embodiments;

FIG. 9B is a flowchart illustrating an example operation of a device of a base station for identifying whether an interference factor of a noise-and-interference covariance matrix is within an abnormal range according to various embodiments;

FIG. 10 is a graph illustrating an example of performance in accordance with adaptive selection of a noise-and-interference covariance matrix according to various embodiments;

FIG. 11A is a block diagram illustrating an example configuration of a digital unit (DU) according to various embodiments; and

FIG. 11B is a block diagram illustrating an example configuration of a radio unit (RU) according to various embodiments.

### DETAILED DESCRIPTION

Terms used in the present disclosure are used to describe various example embodiments, and are not be intended to limit a range of the disclosure. A singular expression may include a plural expression unless the context clearly means otherwise. Terms used herein, including a technical or a scientific term, may have the same meaning as those generally understood by a person with ordinary skill in the art described in the present disclosure. Among the terms used in the present disclosure, terms defined in a general dictionary may be interpreted as identical or similar meaning to the contextual meaning of the relevant technology and are not interpreted as ideal or excessively formal meaning unless explicitly defined in the present disclosure. In some cases, even terms defined in the present disclosure may not be interpreted to exclude embodiments of the present disclosure.

In various embodiments of the present disclosure described below, a hardware approach will be described as an example. However, since the various embodiments of the present disclosure include technology that uses both hardware and software, the various embodiments of the present disclosure do not exclude a software-based approach.

In the following description, a term referring to a signal (e.g., signal, information, message, and signaling), a term referring to a resource (e.g., symbol, slot, subframe, radio frame, subcarrier, resource element (RE), resource block (RB), bandwidth part (BWP), and occasion), a term for a computational state (e.g., step, operation, and procedure), a term referring to data (e.g., packet, user stream, information, bit, symbol, and codeword), a term referring to a channel, a term referring to network entities, a term referring to a component of a device, and the like are illustrated for convenience of description. Therefore, the present disclosure is not limited to the terms described below, and other terms having the same or similar technical meanings may be used.

In addition, in the present disclosure, the term ‘greater than’ or ‘less than’ may be used to determine whether a particular condition is satisfied or fulfilled, but this is only a description to express an example and does not exclude description of ‘greater than or equal to’ or ‘less than or equal to’. A condition described as ‘greater than or equal to’ may be replaced with ‘greater than’, a condition described as ‘less than or equal to’ may be replaced with ‘less than’, and a condition described as ‘greater than or equal to and less than’ may be replaced with ‘greater than and less than or equal to’. In addition, hereinafter, ‘A’ to ‘B’ refers to at least one of elements from A (including A) to B (including B). Hereinafter, ‘C’ and/or ‘D’ may refer, for example, to including at least one of ‘C’ or ‘D’, that is, {′C′, ‘D’, and ‘C’ and ‘D’}.

This disclosure describes various example embodiments using terms used in some communication standards (e.g., 3rd Generation Partnership Project (3GPP), extensible radio access network (xRAN), open-radio access network (O-RAN)), but this is merely an example for explanation. Various example embodiments of the present disclosure may also be applied to other communication systems.

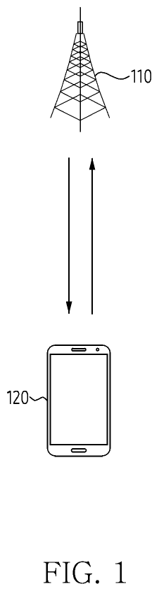

FIG. 1 is a diagram illustrating an example of a wireless communication system according to various embodiments.

Referring to FIG. 1, FIG. 1 illustrates a base station 110 and a terminal 120 as a portion of nodes using a wireless channel in a wireless communication system. Although FIG. 1 illustrates only one base station, the wireless communication system may further include another base station identical to or similar to the base station 110.

The base station 110 is a network infrastructure for providing wireless access to the terminal 120. The base station 110 has coverage defined based on a distance at which a signal may be transmitted. In addition to a base station, the base station 110 may be referred to as an ‘access point (AP)’, an ‘eNode B (eNB)’, a ‘5th generation node’, a ‘next generation node B (gNB)’, a ‘wireless point’, a ‘transmission/reception point (TRP)’, or another term having a technical meaning equivalent thereto.

The terminal 120, which is a device used by a user, communicates with the base station 110 through the wireless channel. A link from the base station 110 to the terminal 120 is referred to as downlink (DL), and a link from the terminal 120 to the base station 110 is referred to as uplink (UL). In addition, although not illustrated in FIG. 1, the terminal 120 and another terminal may perform communication with each other through the wireless channel. In this case, a device-to-device link (D2D) between the terminal 120 and the other terminal is referred to as a sidelink, and the sidelink may be used interchangeably with a PC5 interface. In various embodiments, the terminal 120 may be operated without user involvement. According to an embodiment, the terminal 120, which is a device that performs machine type communication (MTC), may not be carried by the user. In addition, according to an embodiment, the terminal 120 may be a MTC UE or a narrowband (NB)-internet of things (IoT) device.

In addition to a terminal, the terminal 120 may be referred to as ‘user equipment (UE)’, ‘customer premises equipment (CPE)’, a ‘mobile station’, a ‘subscriber station’, a ‘remote terminal’, a ‘wireless terminal’, an ‘electronic device’, or another term having a technical meaning equivalent thereto.

The base station 110 may perform beamforming with the terminal 120. The base station 110 and the terminal 120 may transmit and receive a wireless signal in a relatively low frequency band (e.g., a frequency range 1 (FR 1) of NR). In addition, the base station 110 and the terminal 120 may transmit and receive a wireless signal in a relatively high frequency band (e.g., FR 2 (or FR 2-1, FR 2-2, FR 2-3), or FR 3 of NR), and a mmWave band (e.g., 28 GHz, 30 GHz, 38 GHz, or 60 GHz). To improve a channel gain, the base station 110 and the terminal 120 may perform the beamforming. Herein, the beamforming may include transmission beamforming and reception beamforming. The base station 110 and the terminal 120 may assign directivity to a transmission signal or a reception signal. To this end, the base station 110 and the terminal 120 may select serving beams through a beam search or beam management procedure. After the serving beams are selected, subsequent communication may be performed through a resource that is in a QCL relationship with a resource that has transmitted the serving beams.

If large-scale characteristics of a channel transmitting a symbol on a first antenna port may be estimated from a channel transmitting a symbol on a second antenna port, the first antenna port and the second antenna port may be evaluated to be in the QCL relationship. For example, the large-scale characteristics may include at least one of a delay spread, a Doppler spread, a Doppler shift, an average gain, an average delay, and a spatial receiver parameter.

In FIG. 1, it has been described that both the base station 110 and the terminal 120 perform the beamforming, but the present disclosure is not necessarily limited thereto. In various embodiments, the terminal may or may not perform the beamforming. Also, the base station may or may not perform the beamforming. For example, only one of the base station and the terminal may perform the beamforming, or both the base station and the terminal may not perform the beamforming.

In the present disclosure, a beam, which refers to a spatial flow of a signal in a wireless channel, may be formed by one or more antennas (or antenna elements), and this formation process may be referred to as beamforming. The beamforming may include at least one of analog beamforming or digital beamforming (e.g., precoding). A reference signal transmitted based on the beamforming may include, for example, a demodulation-reference signal (DM-RS), a channel state information-reference signal (CSI-RS), a synchronization signal/physical broadcast channel (SS/PBCH), and a sounding reference signal (SRS). In addition, IE such as a CSI-RS resource or an SRS-resource, and the like, may be used as a configuration with respect to each reference signal, and this configuration may include information associated with the beam. The information associated with the beam may refer, for example, to whether a corresponding configuration (e.g., the CSI-RS resource) uses the same spatial domain filter as another configuration (e.g., another CSI-RS resource within the same CSI-RS resource set) or a different spatial domain filter, or whether it is quasi-co-located (QCL) with a certain reference signal and, if it is QCL, what type (e.g., QCL type A, B, C, or D) it is.

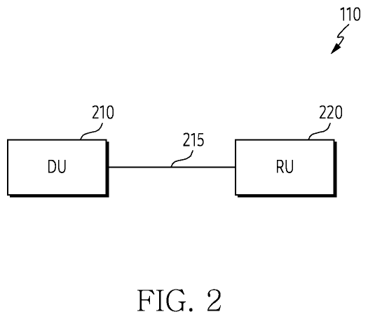

FIG. 2 is a block diagram illustrating an example configuration of a base station according to various embodiments. In FIG. 2, DU and RU in which functions of the base station are divided and implemented by different entities are described. A fronthaul interface may be used for communication between DU and RU. The fronthaul refers to between entities between a wireless radio access network (RAN) and a base station, unlike a backhaul between a base station and a core network. In FIG. 2, it illustrates an example of a fronthaul structure between a DU (e.g., including circuitry) 210 and one RU (e.g., including circuitry) 220, but this is simply for convenience of explanation and the present disclosure is not limited thereto. In other words, an embodiment of the present disclosure may also be applied to a fronthaul structure between one DU and a plurality of RUs. For example, an embodiment of the present disclosure may be applied to a fronthaul structure between one DU and two RUs. In addition, an embodiment of the present disclosure may be applied to a fronthaul structure between one DU and three RUs. In addition, the names of DU and RU are only examples in a distributed deployment scenario and should not be construed as limiting implementation methods of various embodiments of the present disclosure. As a non-limiting example, a device referred to as a massive MIMO unit (MMU) may be connected to the DU and perform operations described below of the RU.

Referring to FIG. 2, the base station 110 may include the DU 210 and the RU 220. A fronthaul 215 between the DU 210 and the RU 220 may be operated through an Fx interface. For an operation of the fronthaul 215, for example, an interface such as an enhanced common public radio interface (eCPRI) and a radio over Ethernet (ROE) may be used.

With development of communication technology, mobile data traffic has increased, and accordingly, a bandwidth requirement amount required by a fronthaul between a digital unit and a wireless unit have increased significantly. In a disposition such as a centralized/cloud radio access network (C-RAN), the DU may be implemented to perform functions with respect to a packet data convergence protocol (PDCP), a radio link control (RLC), a media access control (MAC), and physical (PHY), and the RU may be implemented to perform more functions with respect to a PHY layer in addition to a radio frequency (RF) function.

The DU 210 may handle an upper layer function of a wireless network. For example, the DU 210 may perform a function of a MAC layer and a portion of the PHY layer. Herein, the portion of the PHY layer, which is performed at a higher level among functions of the PHY layer, may include, for example, channel encoding (or channel decoding), scrambling (or descrambling), modulation (or demodulation), layer mapping (or layer demapping). According to an embodiment, in a case that the DU 210 follows an O-RAN standard, it may be referred to as an O-RAN DU (O-DU). The DU 210 may be represented by being replaced with a first network entity for a base station (e.g., gNB) in embodiments of the present disclosure as needed.

The RU 220 may handle a lower layer function of the wireless network. For example, the RU 220 may perform a portion of the PHY layer and an RF function. Herein, the portion of the PHY layer, which is performed at a relatively lower level than the DU 210 among the functions of the PHY layer, may include, for example, iFFT conversion (or FFT conversion), CP insertion (CP removal), and digital beamforming. The RU 220 may be referred to as an ‘access unit (AU), an ‘access point (AP)’, a ‘transmission/reception point (TRP)’, a ‘remote radio head (RRH)’, a ‘radio unit (RU)’, or another term having a technical meaning equivalent thereto. According to an embodiment, in a case that the RU 220 follows the O-RAN standard, it may be referred to as an O-RAN RU (O-RU). The RU 220 may be represented by being replaced with a second network entity for the base station (e.g., the gNB) in various embodiments of the present disclosure as needed.

In FIG. 2, it is illustrated that the base station 110 includes the DU 210 and the RU 220, but the present disclosure is not limited thereto. The base station according to various embodiments may be implemented as a distributed deployment according to a centralized unit (CU) configured to perform functions of upper layers (e.g., a packet data convergence protocol (PDCP), or a radio resource control (RRC)) of an access network, and a distributed unit (DU) configured to perform functions of lower layers. As an example, the distributed unit (DU) may include the digital unit (DU) and the radio unit (RU) of FIG. 2. As another example, the DU may be referred to as a node implemented to perform protocols of CU and DU according to a function split. In addition, as an example, between a core (e.g., a 5G core or a next generation core (NGC)) network and a wireless network (RAN), the base station may be implemented in a structure disposed in an order of the CU, the DU, and the RU. An interface between the CU and the distributed unit (DU) may be referred to as an F1 interface.

The centralized unit (CU) may handle a function of a higher layer than the DU by being connected to one or more DUs. For example, the CU may handle a function of a radio resource control (RRC) and packet data convergence protocol (PDCP) layer, and the DU and the RU may handle a function of a lower layer. The DU may perform radio link control (RLC), media access control (MAC), and some functions (high PHY) of the physical (PHY) layer, and the RU may handle remaining functions (low PHY) of the PHY layer. In addition, as an example, the digital unit (DU) may be included in the distributed unit (DU) according to the distributed deployment implementation of the base station. Hereinafter, it is described as operations of the digital unit (DU) and the RU unless otherwise defined, but various embodiments of the present disclosure may be applied to both a base station deployment including the CU, or a deployment in which the DU is directly connected to a core network (e.g., implemented by being integrated as a base station (e.g., a NG-RAN node) in which the CU and the DU are one entity).

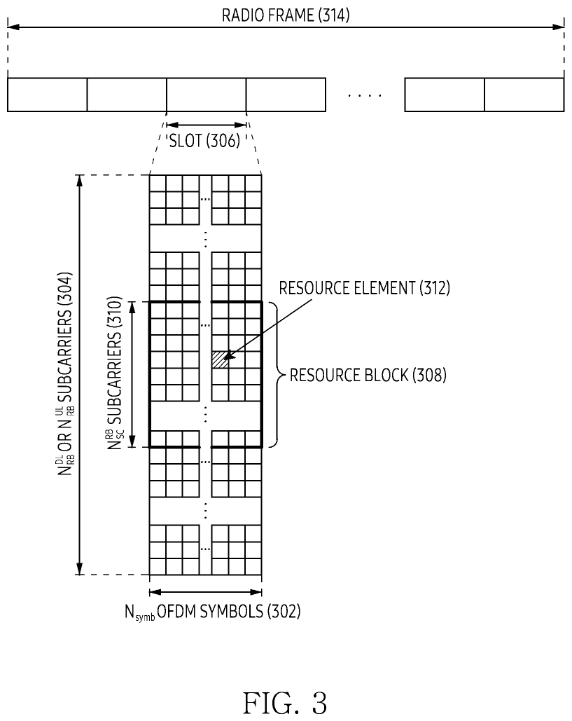

FIG. 3 is a diagram illustrating an example of a resource structure in a time region and a frequency region according to various embodiments. FIG. 3 illustrates a basic structure of a time-frequency region, which is a radio resource region in which data or a control channel is transmitted in downlink or uplink.

Referring to FIG. 3, a horizontal axis indicates the time region and a vertical axis indicates the frequency region. A minimum transmission unit in the time region is an orthogonal frequency division multiplexing (OFDM) symbol, and N_{symb} OFDM symbols 302 include one slot 306. A length of a subframe is defined as 1.0 ms, and a length of a radio frame 314 is defined as 10 ms. A minimum transmission unit in the frequency region is a subcarrier, and a carrier bandwidth including a resource grid may include N_{RB}^{DL} (in a case of downlink) or N_{RB}^{UL} (in a case of uplink) subcarriers 304.

A basic unit of a resource in the time-frequency region is a resource element (hereinafter, ‘RE’) 312, which may be indicated by an OFDM symbol index and a subcarrier index. A resource block may include a plurality of resource elements. In an LTE system, a resource block (RB) (or a physical resource block, hereinafter, ‘PRB’) is defined as N_{symb} consecutive OFDM symbols in the time region and N_{SC}^{RB} consecutive subcarriers in the frequency region. In an NR system, a resource block (RB) 308 may be defined as N_{SC}^{RB} consecutive subcarriers 310 in the frequency region. One RB 308 includes N_{SC}^{RB} REs 312 in the frequency axis. In general, a minimum unit of transmission of data is an RB and the number of subcarriers, N_{SC}^{RB}, is 12. The frequency region may include common resource blocks (CRBs). A physical resource block (PRB) may be defined in a bandwidth part (BWP) on the frequency region. CRB and PRB numbers may be determined according to subcarrier spacing. A data rate may increase in proportion to the number of RBs scheduled for a terminal.

In an NR system, in a case of a frequency division duplex (FDD) system that operates by separating downlink and uplink by frequency, downlink transmission bandwidth and uplink transmission bandwidth may be different from each other. Channel bandwidth indicates radio frequency (RF) bandwidth corresponding to system transmission bandwidth. Table 1 illustrates a portion of a correspondence among system transmission bandwidth, subcarrier spacing (SCS), and channel bandwidth defined in an NR system in a frequency range lower than x GHz (e.g., a frequency range (FR) 1 (310 MHz to 7125 MHZ)). And Table 2 illustrates a portion of a correspondence among transmission bandwidth, subcarrier spacing (SCS), and channel bandwidth defined in the NR system in a frequency range higher than y GHz (e.g., an FR2 (24250 MHZ-52600 MHZ) or an FR2-2 (52600 MHz to 71000 MHz)). For example, in an NR system having 100 MHz channel bandwidth at 30 kHz subcarrier spacing, transmission bandwidth is composed of 273 RBs. In Table 1 and Table 2, N/A may be a bandwidth-subcarrier combination not supported in an NR system.

TABLE 1

| | Channel bandwidth [MHz] | | | | | | |
|---|---|---|---|---|---|---|---|
| | SCS | 5 | 10 | 20 | 50 | 80 | 100 |
| Transmission | 15 kHz | 25 | 52 | 106 | 207 | N/A | N/A |
| bandwidth | 30 kHz | 11 | 24 | 51 | 133 | 217 | 273 |
| configuration | 60 kHz | N/A | 11 | 24 | 65 | 107 | 135 |
| N_{RB} | | | | | | | |

TABLE 2

| Channel | | | | | |
|---|---|---|---|---|---|
| bandwidth | | | | | |
| [MHz] | SCS | 50 | 100 | 200 | 400 |
| Transmission | 60 kHz | 66 | 132 | 264 | N/A |
| bandwidth | 120 kHz | 32 | 66 | 132 | 264 |
| configuration | | | | | |
| N_{RB} | | | | | |

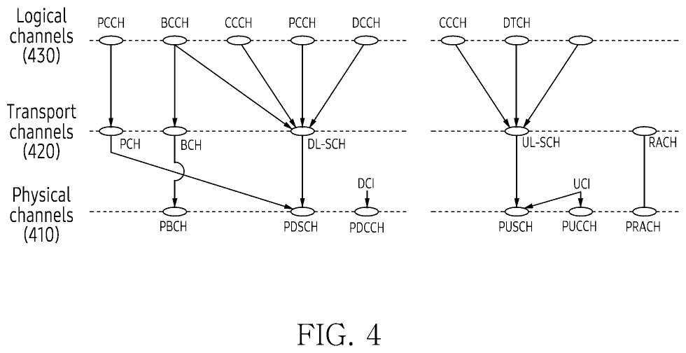

FIG. 4 is a diagram illustrating an example of channels in a communication standard according to various embodiments.

FIG. 4 illustrates an example of channels in a communication standard. The channels may include a physical channel 410, a transport channel 420, and a logical channel 430, in accordance with layers defined in the communication standard.

Referring to FIG. 4, the physical channel 410 may provide functions (e.g., channel coding, HARQ processing, modulation, multiple antenna processing, and resource mapping) necessary to generate physical signals in a physical layer. In the physical layer, the physical signals may be modulated in an OFDM manner and may be transmitted in a wireless environment through a time-frequency resource (e.g., a resource of the resource grid of FIG. 3).

In a downlink transmission, the physical channel 410 may include at least one of a physical broadcast channel (PBCH), a physical downlink shared channel (PDSCH), or a physical downlink control channel (PDCCH). The PDCCH may be used to carry downlink control information (DCI). In general, downlink data may refer to symbols transmitted through the PDSCH, and a downlink control signal may include symbols transmitted through the PDCCH. In addition, in a downlink, in addition to the channels illustrated in FIG. 4, an SS/PBCH block including a synchronization signal (e.g., a primary synchronization signal (PSS) and a secondary synchronization signal (SSS)), and a broadcast signal (e.g., PBCH), may be transmitted for synchronization. In addition, in the downlink, a channel state information-reference signal (CSI-RS) for measurement or obtaining channel information, a demodulation reference signal (DMRS) for channel estimation and demodulation, and a phase tracking reference signal (PTRS) may be transmitted.

In an uplink transmission, the physical channel 410 may include at least one of a physical uplink shared channel (PUSCH), a physical uplink control channel (PUCCH), or a physical random access channel (PRACH). The PUSCH or the PUCCH may be used to carry uplink control information (UCI). In general, uplink data may refer to symbols transmitted through the PUSCH, and an uplink control signal may include symbols corresponding to the UCI. For example, the UCI may include at least one of a scheduling request (SR), hybrid automatic request acknowledgement (HARQ-ACK) bit(s), or channel state information (CSI). In addition, in an uplink, in addition to the channels illustrated in FIG. 4, a DMRS for channel estimation and demodulation, and a PTRS may be transmitted in the downlink, for channel estimation.

The transport channel 420 may connect a physical layer and a medium access channel (MAC) layer positioned at a higher level of the physical layer, and may be classified in accordance with how data is transmitted through a radio interface. In the downlink, the transmission channel 420 may include at least one of a paging channel (PCH) for paging, a broadcast channel (BCH) for broadcasting system information, or a downlink shared channel (DL-SCH) for transmitting downlink data. In the uplink, the transmission channel 420 may include at least one of a random access channel (RACH) for transmitting a random access preamble or an uplink shared channel (UL-SCH) for transmitting downlink data.

The logical channel 430 is positioned above a transport channel and is mapped to the transport channel 420. The logical channel 430 may be classified into a control channel for transmitting control region information and a traffic channel for transmitting user region information. The control channel of the logical channel 430 may include at least one of a paging control channel (PCCH), a broadcast control channel (BCCH), a common control channel (CCCH), or a dedicated control channel (DCCH). The traffic channel of the logical channel 430 may include a dedicated traffic channel (DTCH).

In describing various embodiments of the present disclosure, a random access signal may include sequences transmitted through the physical random access channel (PRACH). ‘Data’ may include signals other than a reference signal. As an example, ‘data’ obtained by a receiver in uplink communication may include signals transmitted through the PUSCH. However, the PUSCH is merely an example, and various embodiments of the present disclosure may also be applied to other channels (e.g., PDSCH, PBCH, PDCCH, and PUCCH) that require channel estimation.

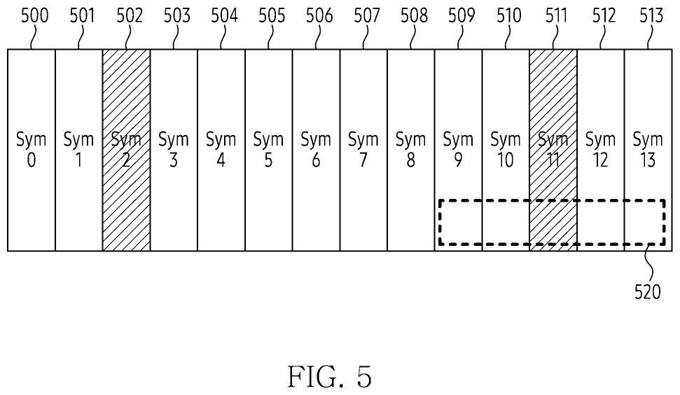

FIG. 5 is a diagram illustrating an example of interference for a physical uplink shared channel (PUSCH) transmission. A DMRS is a reference signal (RS) used for demodulating data. The DMRS may be used to estimate a channel to demodulate data (e.g., PDSCH or PUSCH) and obtain a result of channel estimation. Hereinafter, to describe channel estimation and operations using the DMRS for the channel estimation of the present disclosure, an uplink transmission of an NR communication system is described as an example. However, the present disclosure is not limited to an uplink of the NR communication system. Of course, various embodiments of the present disclosure may also be applied to a downlink or another communication system.

Referring to FIG. 5, a base station (e.g., a base station 110) may receive a signal from a terminal (e.g., a terminal 120). The terminal 120 may transmit an uplink signal to the base station 110. The received signal may include data (hereinafter, reception data) received on an uplink channel (e.g., PUSCH). The reception data may be transmitted in data symbols of a time domain. In addition, the received signal may include reference signals (hereinafter, reception reference signals) (e.g., DMRS) for channel estimation and coherent demodulation of the data symbols. The reception reference signals may be transmitted in DMRS symbols of the time domain. The base station 110 may receive the reception data in the data symbols of a slot and receive the reception reference signals in the DMRS symbols, from the terminal 120. A slot may include 14 symbols (e.g., a symbol #0 500, a symbol #1 501, a symbol #2 502, a symbol #3 503, a symbol #4 504, a symbol #5 505, a symbol #6 506, a symbol #7 507, a symbol #8 508, symbol #9 509, a symbol #10 510, a symbol #11 511, a symbol #12 512, and a symbol #13 513). At least some of the 14 symbols may be used to carry DMRS sequences. For example, an interval of the symbol #2 502 and an interval of the symbol #11 511 may include the DMRS symbols.

The base station 110 may estimate a channel between the base station 110 and the terminal 120 through the reception reference signals. The base station 110 may obtain information on a channel experienced by the reception reference signals. For example, the base station 110 may obtain information on a channel experienced by the reception data through a relationship between a position to which the DMRS symbols of the reception reference signals are mapped and positions to which the data symbols of the reception data are mapped. As an example, the base station 110 may obtain the information on the channel experienced by the reception reference signals by performing interpolation in a frequency domain or interpolation in a time domain based on the information on the channel experienced by the reception reference signals. However, since the number of data symbols within one slot, which is a transmission unit, is generally greater than the number of DMRS symbols, an operation of estimating a channel experienced by each data symbol may require a large amount of computation. Furthermore, since a computation for the DMRS symbols themselves or inter-cell interference may not be reflected, reception performance may not be guaranteed. To this end, the base station 110, which is a reception end, may use various reception techniques.

Various embodiments of the present disclosure relate to a receiver for improving reception performance of the PUSCH in an interference environment having various patterns. A network entity (e.g., the base station 110, a DU 210, an RU 220) including a channel estimation block of the receiver may estimate an auto-covariance matrix (hereinafter, a noise-and-interference covariance matrix) of a noise component and an interference component based on the DMRS symbols (e.g., the symbol #2 502, the symbol #11 511). For example, the receiver may include a minimum mean square error (MMSE) receiver.

A relationship between a transmission signal and the reception signal may be represented as follows.

$$y = Hx + i + n \qquad [ Equation l ]$$

y indicates a reception signal, H indicates a channel between a transmission end and H a reception end, x indicates a transmission signal, i indicates an interference component, and n indicates a noise component.

Noise and interference (NI) may be estimated based on the reception signal y, a sequence x, and the channel H, of the DMRS. The NI may correspond to the noise-and-interference covariance matrix. For example, the noise-and-interference covariance matrix may be represented by the following equation.

$${R}_{nn} = E \{ ( y - Hx ) {( y - Hx )}^{H} \} \qquad [ Equation 2 ]$$

Noise and interference (NI) may be estimated based on the reception signal y, the transmission signal x, and the channel H, of the DMRS. The NI may correspond to the noise-and-interference covariance matrix. For example, the noise-and-interference covariance matrix may be represented by the following equation.

To increase accuracy of estimation of the noise component and the interference component, one noise-and-interference covariance matrix (e.g., an Rₙₘ value) may be obtained based on a plurality of time-frequency resources and DMRSs. At this time, under a assumption that a noise component and an interference component (hereinafter, a noise-and-interference component or an NI component) are similar between an adjacent RB or an adjacent symbol, an average operation may be used to obtain one noise-and-interference covariance matrix.

Assume an environment in which interference enters a specific RB or a specific symbol within a slot. For example, interference 520 may occur due to another signal (e.g., PUCCH) or a signal of another cell (e.g., a mini-slot of another cell) across the symbol #9 509, the symbol #10 510, the symbol #11 511, the symbol #12 512, and the symbol #13 513. The assumption that the noise-and-interference component are similar between the adjacent RB or the adjacent symbol may not be established. In addition, since the estimated NI is not nulled due to an interference signal, performance of the receiver deteriorates. To prevent and/or reduce such deterioration, a resource region in which the same noise-and-interference component is assumed may be set to be smaller. However, since the receiver may not accurately know which resource (e.g., RE) has an interference component, a noise-and-interference component estimated through the resource region set to be small may not be accurate. In addition, if the resource region is set to be large, the estimated noise-and-interference component may not be accurate due to interference in another cell or interference caused by a signal of another channel. This is because the same noise-and-interference component is applied to both an RE in which interference has entered and an RE without interference.

To address the above-described problems, the present disclosure provides a technique for estimating a noise covariance matrix suitable for an interference environment by determining presence or absence of interference in the interference environment. The presence or absence of interference may refer, for example, to whether interference exists to a degree that affects reception performance of the receiver. For example, assume a combiner (e.g., sn MMSE combiner) of the receiver receiving (y) an uplink signal (e.g., PUSCH). An output \hat{x} of the MMSE combiner is as follows.

$$\hat{x} = {W}^{H} y = {{H}^{H} ( {HH}^{H} + {R}_{nn} )}^{- 1} y \qquad [ Equation 3 ]$$

Rₙₙ indicates a noise-and-interference covariance matrix and W indicates a weight of the MMSE combiner.

A well-estimated Rₙₙ may provide high reception performance by nulling the noise component and the interference component. Rₙₙ may be estimated based on the reference signals. To increase estimation accuracy, an average operation E{ } may be used. The average operation may be performed over at least one symbol and at least one RB to which the reference signals are mapped. For example, Rₙₙ may be estimated based on Equation 2.

The reception signal y may include interference I of a neighboring cell. If the interference signal has entirely entered an allocated resource (e.g., a symbol or an RB), Rₙₙ obtained through the average operation may provide optimal performance. However, in a case that an interference signal exists only in a partial region (e.g., a mini-slot) within a slot, the noise-and-interference component of the resource region affects a resource region without the interference signal. This effect provides unnecessary nulling in the resource region without the interference signal and provides inaccurate interference nulling in the resource region with the interference signal. That is, in a case that the interference signal exists in a local area of the reception signal, channel estimation in accordance with the Rₙₙ obtained through the average operation instead causes a performance degradation of the receiver. Therefore, in embodiments of the present disclosure, instead of obtaining Rₙₙ through the average operation in a region affected by interference, an electronic device and a method are disclosed for performing channel estimation of a corresponding data symbol based on Rₙₙ of an adjacent RS.

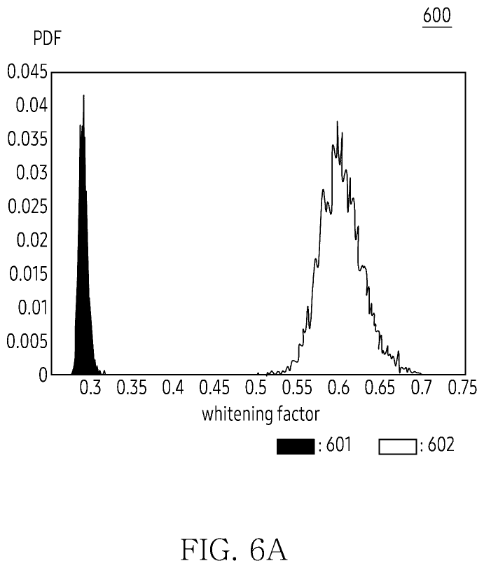

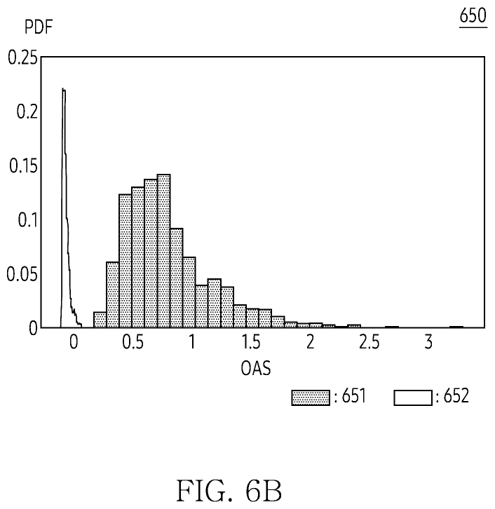

FIGS. 6A and 6B are graphs examples of an interference factor for identifying interference according to various embodiments. The interference factor may be determined based on a noise-and-interference covariance matrix. The interference factor may include a whitening factor or oracle approximating shrinkage (OAS).

Referring to FIG. 6A, a graph 600 indicates a distribution (e.g., a probability density function (PDF)) of the whitening factor in each of an environment 601 (e.g., an interference to noise ratio (INR)—30 decibel (dB)) without an interference signal and an environment 602 (e.g., INR 10 dB) with an interference signal. An x-axis of the graph 600 indicates the whitening factor, and a y-axis of the graph 600 indicates a probability of having the whitening factor corresponding to the x-axis in each of the environment 601 and the environment 602.

The whitening factor may be determined based on a noise-and-interference covariance matrix. The whitening factor may be determined based on a diagonal term of the noise-and-interference covariance matrix and norm information of the noise-and-interference covariance matrix. For example, the whitening factor may be determined based on the following equation.

$$k [ r s , r b ] = \frac{{‖ {R}_{nn} ‖}_{F}}{t r ( {R}_{nn} )} = f ( {R}_{nn} ) \qquad [ Equation 4 ]$$

k[rs,rb] indicates the whitening factor at a reference signal rs and a specific resource RB. Rₙₙ indicates the noise-and-interference covariance matrix at the reference signal rs and the specific resource RB. The reference signal rs may correspond to a symbol (e.g., a symbol #2 502 or a symbol #11 511) within a slot. ∥Rₙₙ∥_{F} corresponds to the norm information. For example, ∥A∥_{F} indicates a Frobenius norm of an N×N^{A}-matrix A in accordance with Equation 5. tr(Rₙₙ) corresponds to magnitude of the diagonal term. For example, tr(A) indicates trace of the N×N-matrix A in accordance with Equation 6. N indicates a size of the Rₙₙ-matrix, that is, the number of reception antennas at a receiver.

$${‖ A ‖}_{F} = \sqrt{{\sum }_{i = 0}^{N - 1} \{ {\vert A ( i . i ) \vert}^{2} + 2 {\sum }_{j = i + 1}^{N - 1} {\vert A ( i . j ) \vert}^{2} \}} \qquad [ Equation 5 ]$$

A(i,j) indicates an element corresponding to a i-th row and a j-th column of a matrix A.

$$𝔱 r ( A ) = {\sum }_{i = 0}^{N - 1} real ( A ( i , i ) ) \qquad [ Equation 6 ]$$

According to Equation 4, the whitening factor may have the following range.

$$\frac{1}{\sqrt{N}} \leq k [ rs , rb ] \leq 1 \qquad [ Equation 7 ]$$

For example, in an identity matrix without interference, the whitening factor may have a value of

$$\frac{1}{\sqrt{N}} .$$

On the other hand, if the interference signal is large, an influence of an off-diagonal term increases (while an influence of the diagonal term decreases relatively) as illustrated in the graph 600, so the whitening factor may have a value close to 1.

Referring to FIG. 6B, a graph 650 indicates a probability density function (PDF) of the OAS. The graph 650 indicates a distribution (e.g., PDF) of an OAS value for an environment 651 without an interference signal and a distribution of an OAS value for an environment 652 (e.g., INR 10 dB) with an interference signal. An x-axis of the graph 650 indicates the OAS value, and a y-axis of the graph 650 indicates a probability of having the OAS value corresponding to the x-axis in each of the environment 651 and the environment 652.

The OAS value may be determined based on a noise-and-interference covariance matrix. The OAS value may be determined based on the diagonal term of the noise-and-interference covariance matrix, the norm information of the noise-and-interference covariance matrix, the number of reception antennas at the receiver, and the number of samples. For example, the OAS value may be determined based on the following equation.

$$ρ [ rs , rb ] = \frac{( 1 - \frac{2}{N} ) {‖ {R}_{nn} ‖}_{F}^{2} + t {r ( {R}_{nn} )}^{2}}{( n + 1 - \frac{2}{N} ) ( {‖ {R}_{nn} ‖}_{F}^{2} - \frac{t {r ( {R}_{nn} )}^{2}}{N} )} = f ( {R}_{nn} ) \qquad [ Equation 8 ]$$

ρ[rs,rb] indicates the OAS value at the reference signal rs and the specific resource RB. n indicates the number of accumulated samples when calculating Rₙₙ. For example, for calculating Rₙₙ, n may be greater than or equal to the number of samples corresponding to 2 RB in accordance with a central limit theorem. ∥Rₙₙ∥_{F} corresponds to the norm information. tr(Rₙₙ) corresponds to magnitude of the diagonal term. N indicates the number of reception antennas.

The OAS value in accordance with Equation 8 may be greater than or equal to 0. An OAS value of the identity matrix may be greater than 1 (e.g., ρ>>1). On the other hand, if the interference signal is large, the influence of the diagonal term decreases, and as illustrated in the graph 650, the OAS value may have a value close to 0.

As illustrated in the graph 600 and the graph 650, the interference factor has different distributions in accordance with an influence of an interference signal included in a reception signal. Based on the distribution of the interference factor, it may be determined through an average operation whether to perform channel estimation of a data symbol through Rₙₙ or to perform channel estimation of the data symbol through Rₙₙ of an adjacent RS. In FIGS. 6A to 6B, the whitening factor and the OAS value are illustrated as parameters for determining an influence of the interference, but embodiments of the present disclosure are not limited thereto. Of course, another parameter having the same or similar technical meaning, in addition to the above-described interference factors, may be used to identify whether there is an influence of the interference signal. For example, the influence of the interference signal may be determined through a parameter for a strength of the interference (hereinafter, interference level). As an example, based on the magnitude of the diagonal term of the noise-and-interference covariance matrix, e.g., the trace value, tr(Rₙₙ), whether there is an influence due to the interference signal on the data symbol may be determined.

Hereinafter, functional blocks for selecting Rₙₙ for channel estimation of the data symbol based on the interference factor are described in greater detail with reference to various figures.

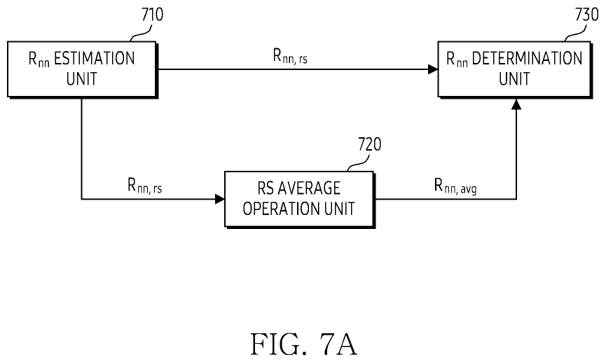

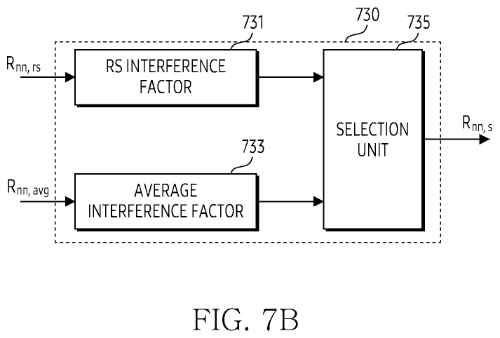

FIGS. 7A and 7B are diagrams illustrating an example of functional blocks for adaptively selecting a noise-and-interference covariance matrix according to various embodiments. Each functional block may be understood as an operation in a network entity (e.g., a base station 110, a DU 210, or an RU 220) corresponding to a receiver. A term such as ‘ . . . unit’, ‘ . . . device’, and the like, used hereinafter, may refer to a unit that processes at least one function or operation, and may be implemented as hardware (e.g., including various circuitry) or software, or a combination of hardware and software.

Referring to FIG. 7A, the receiver may include an Rₙₙ estimation unit 710, an RS average operation unit 720, and an Rₙₙ determination unit 730. The Run estimation unit 710 may estimate a noise-and-interference covariance matrix Rₙₙ corresponding to a DMRS symbol (e.g., a symbol #2 502 or a symbol #11 511). For example, the Rₙₙ estimation unit 710 may estimate the noise-and-interference covariance matrix Rₙₙ in a time interval (e.g., a symbol rs) corresponding to the DMRS symbol and in a frequency domain in accordance with an RB, based on Equation 2. For example, the Rₙₙ estimation unit 710 may output a noise-and-interference covariance matrix R_{nn,rs} estimated from the symbol rs.

The RS average operation unit 720 may output an averaged noise-and-interference covariance matrix R_{nn, avg}. The RS average operation unit 720 may perform an average operation on noise-and-interference covariance matrices of DMRS symbols. For example, the RS average operation unit 720 may perform average operation based on the following equation.

$${R}_{nn , aνg} = \frac{1}{{n}_{DMRS}} {\sum }_{rs = 0}^{rs = {n}_{DMRS} - 1} {R}_{nn , rs} \qquad [ Equation 9 ]$$

R_{nn,avg} indicates the averaged noise-and-interference covariance matrix and n_{DMRS} indicates the number of the DMRS symbols. R_{nn,rs} indicates the noise-and-interference covariance matrix estimated from the symbol rs.

The Rₙₙ determination unit 730 may determine a noise-and-interference covariance matrix to be applied to a data symbol. The Rₙₙ determination unit 730 may determine the noise-and-interference covariance matrix to be applied to the data symbol based on the averaged noise-and-interference covariance matrix R_{nn,avg} and the noise-and-interference covariance matrix R_{nn,rs} of the DMRS symbol. The Rₙₙ determination unit 730 may identify whether interference exists in the data symbol based on the averaged noise-and-interference covariance matrix R_{nn,avg} and the noise-and-interference covariance matrix R_{nn,rs} of the DMRS symbol. The Rₙₙ determination unit 730 may determine a noise-and-interference covariance matrix to be used for channel estimation of the data symbol in accordance with presence or absence of interference. For example, the Rₙₙ determination unit 730 may select one of the averaged noise-and-interference covariance matrix R_{nn,avg} or the noise-and-interference covariance matrix R_{nn,rs} of the DMRS symbol. The DMRS symbol may be most adjacent to the data symbol among the DMRS symbols used for the average operation.

A noise-and-interference component in the data symbol may follow a noise-and-interference component of an adjacent DMRS symbol of the data symbol. However, a value (e.g., the averaged noise-and-interference covariance matrix R_{nn,avg}) that sufficiently averages noise-and-interference covariance matrices of a sufficient number of adjacent DMRS symbols may be a more accurate noise-and-interference component in an environment with low interference. This is because the noise-and-interference component is a value derived in accordance with a statistical distribution. For example, the DMRS symbols may be DMRS symbols within a certain distance from the data symbol on a resource grid. Conversely, if a specific data symbol is under an influence of an interference signal, the noise-and-interference component of the adjacent DMRS symbol may more accurately reflect a channel than the value that sufficiently averages the DMRS symbols.

Referring to FIG. 7B, the Rₙₙ determination unit 730 may include an RS interference factor determination unit 731, an average interference factor determination unit 733, and a selection unit 735.

The RS interference factor determination unit 731 may obtain the noise-and-interference covariance matrix R_{nn,rs} for each DMRS symbol. The RS interference factor determination unit 731 may determine an interference factor (hereinafter, an RS interference factor or a second interference factor) for the noise-and-interference covariance matrix of the DMRS symbol. For example, the RS interference factor determination unit 731 may determine a whitening factor of the noise-and-interference covariance matrix of the DMRS symbol. In addition, for example, the RS interference factor determination unit 731 may determine an OAS value of the noise-and-interference covariance matrix of the DMRS symbol. In addition, for example, the RS interference factor determination unit 731 may determine a trace value of the noise-and-interference covariance matrix of the DMRS symbol.

The average interference factor determination unit 733 may obtain the averaged noise-and-interference covariance matrix R_{nn,avg} for the DMRS symbols. The average interference factor determination unit 733 may determine an interference factor (hereinafter, an average interference factor or a first interference factor) for the averaged noise-and-interference covariance matrix. For example, the average interference factor determination unit 733 may determine a whitening factor of the averaged noise-and-interference covariance matrix. In addition, for example, the average interference factor determination unit 733 may determine an OAS value of the averaged noise-and-interference covariance matrix. In addition, for example, the average interference factor determination unit 733 may determine a trace value of the averaged noise-and-interference covariance matrix.

The selection unit 735 may select one of the averaged noise-and-interference covariance matrix or the noise-and-interference covariance matrix of the DMRS symbol. For example, the DMRS symbol may be a DMRS symbol within a certain distance from the data symbol of a received signal, based on a resource grid. In addition, for example, the DMRS symbol may correspond to a symbol most adjacent to the data symbol among transmitted DMRS symbols, based on the resource grid. Through the selection unit 735, the noise-and-interference covariance matrix Rₙₙ for the data symbol may be obtained for channel estimation of the data symbol. In a case that there is interference within a slot or an RB region, to increase accuracy of estimating the noise-and-interference component, instead of always performing an average operation, the average operation may be performed adaptively. The receiver may perform channel estimation on the data symbol to receive an uplink signal (e.g., PUSCH). The receiver may calculate a weight in an MMSE combiner through the noise-and-interference covariance matrix Rₙₙ described in FIGS. 7A to 7B.

The selection unit 735 may use various algorithms to select one of the averaged noise-and-interference covariance matrix or the noise-and-interference covariance matrix of the DMRS symbol.

According to an embodiment, the selection unit 735 may select one of the averaged noise-and-interference covariance matrix or the noise-and-interference covariance matrix of the DMRS symbol based on whether a difference between the first interference factor and the second interference factor is greater than or equal to a threshold. For example, the selection unit 735 may determine a noise-and-interference covariance matrix R_{nn,s} to be applied to the data symbol, based on the OAS value. As an example, a condition using the OAS value may be represented by the following equation.

$$if \vert {ρ}_{0} ( s ) - {ρ}_{1} ( s ) \vert > {TH}_{ρ} , {R}_{nn , s} = {R}_{nn , 1} else {R}_{nn , s} = {R}_{nn , 0} \qquad [ Equation 10 ]$$

ρ₀(s) indicates the first interference factor, ρ₁(s) indicates the second interference factor, and TH_{ρ} indicates an OAS threshold. R_{nn,0} refers to the averaged noise-and-interference covariance matrix and refers to the noise-and-interference covariance matrix of the DMRS symbol adjacent to the data symbol.

For another example, the selection unit 735 may determine the noise-and-interference covariance matrix R_{nn,s} to be applied to the data symbol, based on the whitening factor. As an example, a condition using the whitening factor may be represented by the following equation.

$$if \vert {k}_{0} ( s ) - {k}_{1} ( s ) \vert > {TH}_{k} , {R}_{nn , s} = {R}_{nn , 1} else {R}_{nn , s} = {R}_{nn , 0} \qquad [ Equation 11 ]$$

k₀(s) indicates the first interference factor, k₁(s) indicates the second interference factor, and THₖ indicates the whitening threshold. R_{nn,0} refers to the averaged noise-and-interference covariance matrix and R_{nn,1} refers to the noise-and-interference covariance matrix of the DMRS symbol adjacent to the data symbol.

According to an embodiment, the selection unit 735 may select one of the averaged noise-and-interference covariance matrix or the noise-and-interference covariance matrix of the DMRS symbol based on whether a ratio of the first interference factor and the second interference factor is greater than or equal to the threshold. For example, the selection unit 735 may determine the noise-and-interference covariance matrix R_{nn,s} to be applied to the data symbol, based on magnitude of a diagonal term. As an example, a condition using the magnitude of the diagonal term may be represented by the following equation.

$$if or ( \frac{t r ( {R}_{nn , 0} )}{t r ( {R}_{nn , 1} )} > {TH}_{H} , \frac{t r ( {R}_{nn , 0} )}{t r ( {R}_{nn , 1} )} < {TH}_{L} ) , \qquad [ Equation 12 ]$$

$${R}_{nn , s} = {R}_{nn , 1} else {R}_{nn , s} = {R}_{nn , 0}$$

tr(R_{nn,0}) indicates the first interference factor, tr(R_{nn,1}) indicates the second interference factor, TH_{H} indicates an upper threshold of a normal range, and TH_{L} indicates a lower threshold of the normal range. R_{nn,0} refers to the averaged noise-and-interference covariance matrix and R_{nn,1} refers to the noise-and-interference covariance matrix of the DMRS symbol adjacent to the data symbol. If it is out of the normal range, that is, if a noise-and-interference component is higher than an average, the receiver may use a noise-and-interference covariance matrix of an adjacent DMRS symbol instead of the averaged noise-and-interference covariance matrix.

Determining whether an interference factor is within the normal range or outside the normal range (e.g., an abnormal range) through a ratio may be applied not only a case of using the magnitude of the diagonal term as the interference factor, but also a case of using the whitening factor or the OAS value. For example, a condition using the OAS value may be represented by the following equation.

$$if or ( \frac{{ρ}_{0} ( s )}{{p}_{1} ( s )} > T {H}_{H} , \frac{{p}_{0} ( s )}{{p}_{1} ( s )} < T {H}_{L} ) , \qquad [ Equation 13 ]$$

$${R}_{nn , s} = {R}_{nn , 1} else {R}_{nn , s} = {R}_{nn , 0}$$

ρ₀(s) indicates the first interference factor and ρ₁(s) indicates the second interference factor. TH_{H} indicates the upper threshold of the normal range, and TH_{L} indicates the lower threshold of the normal range. R_{nn,0} refers to the averaged noise-and-interference covariance matrix and R_{nn,1} refers to the noise-and-interference covariance matrix of the DMRS symbol adjacent to the data symbol.

In addition, for example, a condition using the whitening factor may be represented by the following equation.

$$if or ( \frac{{k}_{0} ( s )}{{k}_{1} ( s )} > T {H}_{H} , \frac{{k}_{0} ( s \}}{{k}_{1} ( s )} < T {H}_{L} ) , \qquad [ Equation 14 ]$$

$${R}_{nn , s} = {R}_{nn , 1} else {R}_{nn , s} = {R}_{nn , 0}$$

k₀(s) indicates the first interference factor, k₁(s) indicates the second interference factor, TH_{H} indicates the upper threshold of the normal range, and TH_{L} indicates the lower threshold of the normal range. R_{nn,0} refers to the averaged noise-and-interference covariance matrix and R_{nn,1} refers to the noise-and-interference covariance matrix of the DMRS symbol adjacent to the data symbol.

In a case (e.g., 2×2 Rₙₙ) that the number of reception antennas of the receiver is less than a reference value (e.g., 2), it is more advantageous for reception performance to distinguish the interference signal using the magnitude of the diagonal term, e.g., a trace function, other than using the whitening factor or the OAS value. The number of reception antennas may be dependent on a rank of an uplink channel. This is because it is difficult to accurately derive an off-diagonal term due to the small number of antennas.

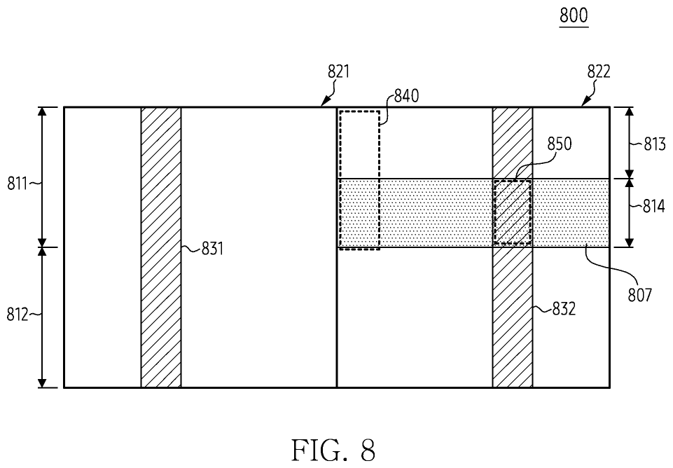

FIG. 8 is a diagram illustrating an example of an average operation of a noise-and-interference covariance matrix according to various embodiments. An environment in which interference of a certain strength or more (e.g., an INR of 10 dB or more) exists in a partial region within a slot is described.

Referring to FIG. 8, a resource region 800 may include time-frequency resources.

A vertical axis of the resource region 800 indicates a frequency domain. For example, the frequency domain may be configured in units of a resource block (RB). The resource region 800 may include a first RB region 811 and a second RB region 812. The first RB region 811 may include one or more RBs. The second RB region 812 may include one or more RBs. The first RB region 811 may include a third RB region 813 and a fourth RB region 814. The third RB region 813 may include one or more RBs. The fourth RB region 814 may include one or more RBs.

A horizontal axis of the resource region 800 indicates a time domain. For example, the resource region 800 may correspond to a time interval of one slot. A slot of the resource region 800 may include two sub-slots. For example, the slot may include a first sub-slot 821 and a second sub-slot 822. The slot may include a plurality of symbols. For example, the slot may include 14 symbols. At least one symbol among the 14 symbols may be a DMRS symbol. A DMRS symbol, which is a symbol to which DMRS is mapped, may be a reference for channel estimation. Among the 14 symbols, other symbols except for the at least one symbol may be data symbols. Channel information estimated through the DMRS symbol may be used for channel estimation of the data symbol. For example, the slot may include a first DMRS symbol and a second DMRS symbol. A first DMRS 831 may be mapped to the first DMRS symbol. A second DMRS 832 may be mapped to the second DMRS symbol.

An interference signal 807 may be transmitted to a partial portion of the time-frequency resources of the resource region 800. For example, the interference signal 807 may be an uplink signal or a downlink signal of another cell. In addition, for example, the interference signal 807 may include a communication signal having a different numerology (e.g., ultra-reliable and low latency communications (URLLC)). In addition, for another example, the interference signal 807 may include uplink control information (UCI) received on a PUCCH. Due to frequency hopping of the PUCCH, the interference signal 807 may flow into only a specific sub-slot (e.g., the second sub-slot 822) within a slot in a specific frequency resource region (e.g., the fourth RB region 814).

Since there is no interference in the first sub-slot 821, while the interference signal 807 exists in the second sub-slot 822, a receiver (e.g., a base station 110, a DU 210, or an RU 220) may not perform an average operation. For example, the receiver may obtain data corresponding to the uplink signal based on a noise-and-interference covariance matrix obtained through the first DMRS 831 for a data symbol within the first sub-slot 821 without performing the average operation. Similarly, the receiver may obtain the data corresponding to the uplink signal based on a noise-and-interference covariance matrix obtained through the second DMRS 832 for a data symbol within the second sub-slot 822.

The average operation may be performed in the time domain or the frequency domain. For example, the average operation may be performed on DMRS symbols (e.g., the first DMRS symbol and the second DMRS symbol) of the time domain. The receiver may obtain a noise-and-interference covariance matrix for a data symbol within a data region 840. The receiver may first obtain an averaged noise-and-interference covariance matrix. The receiver may determine a noise-and-interference covariance matrix of the first DMRS 831 based on the first DMRS 831. The receiver may determine a noise-and-interference covariance matrix of the second DMRS 832 based on the second DMRS 832. The receiver may determine the averaged noise-and-interference covariance matrix (hereinafter, referred to as a first noise-and-interference covariance matrix) through an average operation of the noise-and-interference covariance matrix of the first DMRS 831 and the noise-and-interference covariance matrix of the second DMRS 832. The receiver may select one of the noise-and-interference covariance matrix of the second DMRS 832, which is a DMRS symbol adjacent to the data region 840, and the averaged noise-and-interference covariance matrix.

For example, the average operation may be performed on DMRS symbols (e.g., symbols of the second DMRS 822) of the frequency domain. The receiver may obtain a noise-and-interference covariance matrix for a data symbol in a data region 850. The receiver may first obtain the averaged noise-and-interference covariance matrix. The receiver may obtain DMRS symbols of the second DMRS 832. The DMRS symbols may be mapped to the same time domain of the second DMRS 832, and the DMRS symbols may have different frequency regions (e.g., the third frequency region 813, the fourth frequency region 814). The receiver may determine the averaged noise-and-interference covariance matrix based on the average operation of the noise-and-interference covariance matrices of the DMRS symbols. The receiver may determine a second noise-and-interference covariance matrix based on a DMRS symbol corresponding to a specific frequency region (e.g., the fourth frequency region 814) of the DMRS symbols. The receiver may select one of the averaged noise-and-interference covariance matrix and the second noise-and-interference covariance matrix.

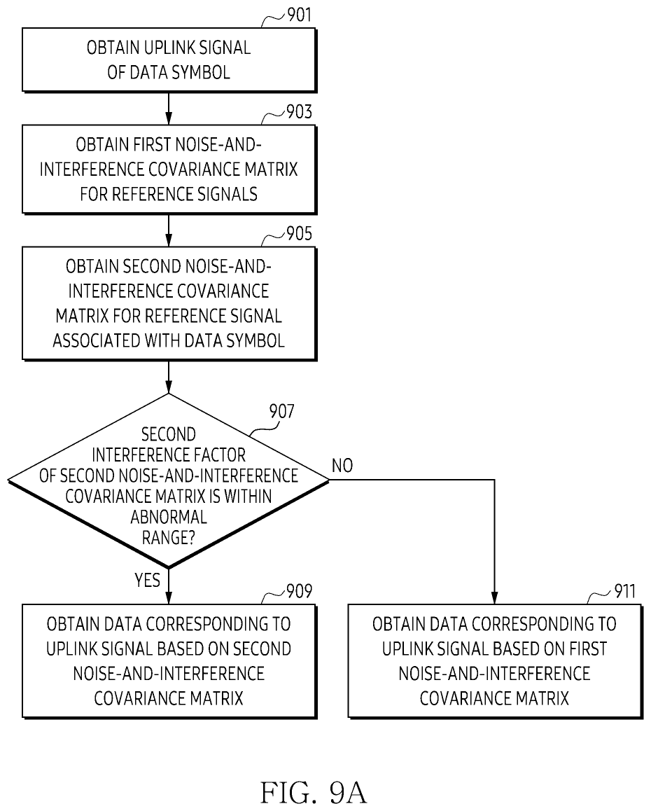

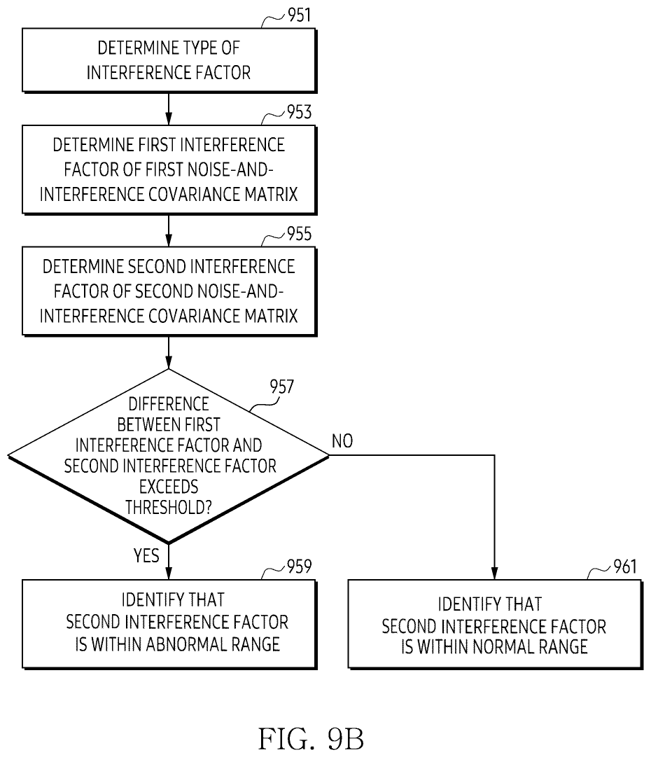

FIG. 9A is a flowchart illustrating an example operation of a device (e.g., a DU 210) of a base station for adaptively selecting a noise-and-interference covariance matrix according to various embodiments. Although an operation of the DU 210 is described in FIG. 9A, the present disclosure is not limited thereto. According to an embodiment, in a case that the DU 210 and an RU 220 may be implemented in one network entity without physical split, all operations described below may be understood as being performed by a base station (e.g., a base station 110), which is a single network entity. In addition, according to an embodiment, in a case that a channel estimation block is implemented in the RU 220 other than in the DU 210, in a type of functional split, the operations described below may be performed by the RU 220.

Referring to FIG. 9A, in operation 901, the device may obtain an uplink signal of a data symbol. For example, the uplink signal may include a PUSCH signal. Reference signals may be transmitted together with the PUSCH signal within a subframe or a slot through which the PUSCH signal is transmitted. The reference signals may include DMRSs. A symbols other than a symbol through which DMRSs are transmitted may be referred to as a data symbol. The device may obtain an uplink signal mapped to the data symbol. The device may perform operations described below to obtain a transmission signal corresponding to the uplink signal.

In operation 903, the device may obtain a first noise-and-interference covariance matrix for the reference signals. The device may determine a noise-and-interference covariance matrix of each reference signal of the reference signals. The device may obtain noise-and-interference covariance matrices of the reference signals. The device may determine a representative value for the obtained noise-and-interference covariance matrices. For example, the device may determine the first noise-and-interference covariance matrix through an average operation on the obtained noise-and-interference covariance matrices. In addition, for example, the device may determine the first noise-and-interference covariance matrix through a median value operation on the obtained noise-and-interference covariance matrices. In addition, for example, the device may determine the first noise-and-interference covariance matrix through a weighted-average operation on the obtained noise-and-interference covariance matrices.

In operation 905, the device may obtain a second noise-and-interference covariance matrix for a reference signal associated with the data symbol. The device may identify the reference signal associated with the data symbol. For example, the device may identify a reference signal most adjacent to the data symbol, among reference signals within the slot in which the uplink signal is transmitted. In addition, for example, the device may identify at least one reference signal mapped within a certain distance from the data symbol, among the reference signals within the slot in which the uplink signal is transmitted. As an example, the certain distance may be defined as a distance in accordance with a time-frequency domain on a resource grid. The device may identify one signal among the at least one identified reference signal. The device may obtain the second noise-and-interference covariance matrix based on the identified reference signal.

In operation 907, the device may identify whether a second interference factor of the second noise-and-interference covariance matrix is within an abnormal range.

The device may apply a function for determining an interference factor to the first noise-and-interference covariance matrix. The device may determine a first interference factor for the first noise-and-interference covariance matrix. The device may apply a function for determining an interference factor to the second noise-and-interference covariance matrix. The device may determine the second interference factor for the second noise-and-interference covariance matrix. The device may determine whether the second interference factor is within the abnormal range based on the first interference factor. The first interference factor indicates an interference degree of an averaged noise-and-interference covariance matrix. Since the second interference factor indicates a characteristic of a noise-and-interference component specific to a local area on the resource grid, a comparison between the first interference factor and the second interference factor may be used to determine whether the second interference factor is within a normal range. An operation of determining whether it is within the abnormal range is described in greater detail below with reference to FIG. 9B.

The device may perform operation 909 in a case that the second interference factor is within the abnormal range (Yes in operation 907). The device may perform operation 911 in a case that the second interference factor is not within the abnormal range (No in operation 907), e.g., in a case that the second interference factor is within the normal range.

In operation 909, the device may obtain data corresponding to the uplink signal based on the second noise-and-interference covariance matrix. The device may determine that an interference component is greater than a certain strength in a data region in which a current data symbol is positioned. The device may determine that using a noise-and-interference component of a DMRS symbol specific to a specific time interval (e.g., the second sub-slot 822 of FIG. 8) is more advantageous than estimating the noise-and-interference component through an average operation within a certain time interval (e.g., the slot of FIG. 8). The device may estimate a channel corresponding to the data symbol. The device may obtain a weight (e.g., W^{H} of Equation 3 for MMSE) to be applied to the uplink signal based on the estimated channel and the second noise-and-interference covariance matrix. The device may obtain the data corresponding to the uplink signal based on the weight. The obtained data may include an estimated transmission signal.

In operation 911, the device may obtain the data corresponding to the uplink signal based on the first noise-and-interference covariance matrix. The device may determine that the interference component is less than or equal to the certain strength in the data region in which the current data symbol is positioned. The device may determine that estimating the noise-and-interference component through the average operation within the certain time interval (e.g., the slot of FIG. 8) is more advantageous than using the noise-and-interference component of the DMRS symbol specific to the specific time interval (e.g., the second sub-slot 822 of FIG. 8). The device may estimate the channel corresponding to the data symbol. The device may obtain the weight (e.g., W^{H} of Equation 3 for MMSE) to be applied to the uplink signal based on the estimated channel and the first noise-and-interference covariance matrix. The device may obtain the data corresponding to the uplink signal based on the weight. The obtained data may include the estimated transmission signal.

FIG. 9B is a flowchart illustrating an example operation of a device of a base station for identifying whether an interference factor of a noise-and-interference covariance matrix is within an abnormal range according to various embodiments. Although an operation of a DU 210 is described in FIG. 9B, the present disclosure is not limited thereto. According to an embodiment, in a case that the DU 210 and an RU 220 are implemented in one network entity without physical split, all operations described below may be understood as being performed by a base station (e.g., a base station 110), which is a single network entity. In addition, according to an embodiment, in a case that a channel estimation block is implemented in the RU 220 other than in the DU 210, in a type of functional split, operations described below may be performed by the RU 220.

Referring to FIG. 9B, in operation 951, the device may determine a type of interference factor.

The device may determine the type of interference factor to determine interference information of a noise-and-interference covariance matrix. The interference factor may include a metric indicating the interference information of the noise-and-interference covariance matrix. For example, the type may include a whitening factor, an OAS value, and magnitude of a diagonal term.

The device may select the type of interference factor based on at least one criterion among various criteria. For example, the device may determine the type of interference factor based on channel information (e.g., rank) of a reception device (e.g., the RU 220). As an example, in a case that the number of reception antennas is 2, measuring an interference component may not be easy. Therefore, among the types of interference factor, a type that uses elements for a signal component may be preferred instead of types (e.g., a whitening factor, an OAS value) that use elements for the interference component. In addition, for example, the device may determine the type of interference factor based on a performance requirement or complexity. In a case that the number of samples for interference is insufficient, the device may determine, among the types of interference factors, the type (e.g., the whitening factor, the OAS value) that uses the elements for the interference component to measure the interference component more accurately.

In operation 953, the device may determine a first interference factor of a first noise-and-interference covariance matrix. The device may identify a function in accordance with the type of interference factor. The device may calculate the first interference factor corresponding to the first noise-and-interference covariance matrix through the function.

In operation 955, the device may determine a second interference factor of a second noise-and-interference covariance matrix. The device may identify a function in accordance with the type of interference factor. The function is identical to the function of the operation 953. The device may calculate the first interference factor corresponding to the first noise-and-interference covariance matrix, using the function.

In operation 957, the device may determine whether a difference between the first interference factor and the second interference factor exceeds a threshold. The first interference factor and the second interference factor are the same parameters corresponding to the type of interference factor. The device may determine the threshold in accordance with the type of interference factor. The device may determine the difference between the first interference factor and the second interference factor. For example, the device may subtract the second interference factor from the first interference factor, and then determine magnitude of the subtracted value.

In a case that the difference between the first interference factor and the second interference factor exceeds the threshold (Yes in operation 957), the device may perform operation 959. In a case that the difference between the first interference factor and the second interference factor does not exceed a threshold (No in operation 957), the device may perform operation 961.

In operation 959, the device may identify that the second interference factor is within the abnormal range. Since an interference degree in a DMRS symbol associated with a data symbol is stronger than an average interference degree within a certain region by a threshold level or more, the device may identify that an interference degree in a current data symbol is abnormal.

In operation 961, the device may identify that the second interference factor is within a normal range. Since the interference degree in the DMRS symbol associated with the data symbol is not stronger than the average interference degree within a certain region by the threshold level or more, the device may identify that the interference degree in the current data symbol is normal.

In FIG. 9B, it is determined based on whether the difference between two interference factors (e.g., the first interference factor and the second interference factor) exceeds the threshold, but a receiver according to embodiments of the present disclosure is not limited thereto. The receiver may perform at least one of various operations to determine whether the second interference factor for a specific RS is within the normal range. For example, the receiver may identify whether a ratio between the two interference factors is greater than or equal to a first threshold or less than a second threshold, to identify that the second interference factor is within the abnormal range.

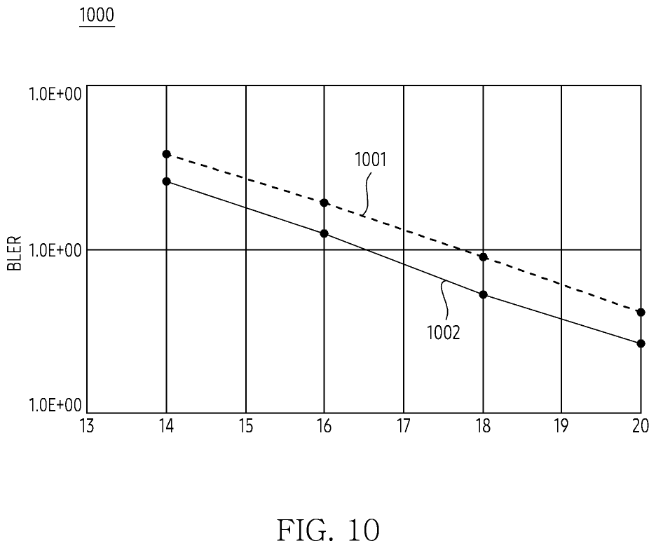

FIG. 10 is a graph illustrating an example of performance in accordance with adaptive selection of a noise-and-interference covariance matrix according to various embodiments.

Referring to FIG. 10, a graph 1000 indicates block error rate (BLER) performance in accordance with signal quality (e.g., SNR). An environment is assumed in which interference (e.g., an INR of 10 dB) of a certain strength or greater is detected in a portion (e.g., a second sub-slot 822) of a resource region. A line 1001 indicates performance using an averaged noise-and-interference covariance matrix. For example, the averaged noise-and-interference covariance matrix may be obtained through an average operation of a noise-and-interference covariance matrix in a first sub-slot (e.g., a first sub-slot 821) and a noise-and-interference covariance matrix in a second sub-slot (e.g., a second sub-slot 822). A line 1002 indicates performance using a noise-and-interference covariance matrix of a DMRS symbol (e.g., the most adjacent DMRS symbol) associated with the data symbol. In an experimental environment of the line 1002, in the first sub-slot (e.g., the first sub-slot 821), a covariance matrix of an RS (e.g., a first DMRS 831) of the first sub-slot is applied, and in the second sub-slot (e.g., the second sub-slot 822), a covariance matrix of an RS (e.g., a second DMRS 832) of the second sub-slot is applied.

Since interference degrees of the first sub-slot and the second sub-slot are different, reception performance of a receiver may be improved by applying a specific noise-and-interference covariance matrix to each sub-slot instead of the average operation. Since the line 1002 provides a lower BLER than the line 1001 in the same SNR, in a case that there is an interference environment in a partial region of specific resource intervals, it may be identified that turning off the average operation for the specific resource intervals is more advantageous than performing the average operation for the specific resource intervals.

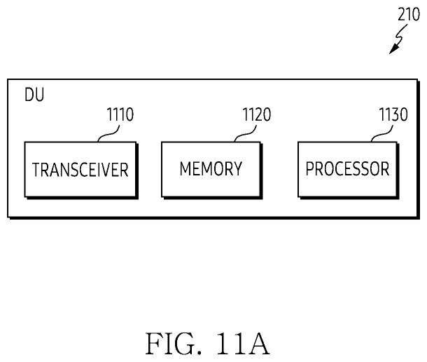

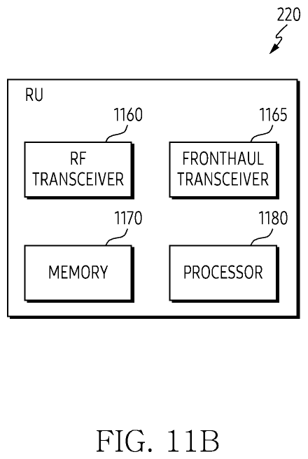

FIG. 11A is a block diagram illustrating an example configuration of a DU (e.g., the DU 210) according to various embodiments. A configuration illustrated in FIG. 11A, which is as a part of a base station, may be understood as a configuration of the DU 210 of FIG. 11A. Hereinafter, the terms ‘ . . . unit’ and ‘ . . . er’ used below refer to a unit processing at least one function or operation, which may be implemented by hardware or software, or a combination of hardware and software.

Referring to FIG. 11A, a DU 210 includes a transceiver 1110, memory 1120, and a processor (e.g., including processing circuitry) 1130.

The transceiver 1110 may include various circuitry and perform functions for transmitting and receiving a signal in a wired communication environment. The transceiver 1110 may include a wired interface for controlling a direct device-to-device connection through a transmission medium (e.g., copper wire, optical fiber). For example, the transceiver 1110 may transmit an electrical signal to another device through a copper wire or perform conversion between an electrical signal and an optical signal. The DU 210 may communicate with a radio unit (RU) through the transceiver 1110.

The transceiver 1110 may also perform functions for transmitting and receiving a signal in a wireless communication environment. For example, the transceiver 1110 may perform a conversion function between a baseband signal and a bit string according to a physical layer specification of a system. For example, upon transmitting data, the transceiver 1110 generates complex-valued symbols by encoding and modulating a transmission bit string. In addition, upon receiving data, the transceiver 1110 restores a received bit string by demodulating and decoding a baseband signal. In addition, the transceiver 1110 may include a plurality of transmission/reception paths.

The transceiver 1110 may transmit and receive a signal. For example, the transceiver 1110 may transmit a management plane (M-plane) message. For example, the transceiver 1110 may transmit a synchronization plane (S-plane) message. For example, the transceiver 1110 may transmit a control plane (C-plane) message. For example, the transceiver 1110 may transmit a user plane (U-plane) message. For example, the transceiver 1110 may receive the U-plane message. Although only the transceiver 1110 is illustrated in FIG. 11A, the DU 210 may include two or more transceivers according to another implementation.

The transceiver 1110 transmits and receives a signal as described above. Accordingly, all or some of the transceiver 1110 may be referred to as a ‘communication unit’, a ‘transmission unit’, a ‘reception unit’, or a ‘transmission/reception unit’. In addition, in the following description, transmission and reception performed through a wireless channel are used to the meaning including that the processing as described above is performed by the transceiver 1110. According to an embodiment, the transceiver 1110 may obtain signals on which physical layer processing has been performed, from the RU (e.g., an RU 220). For example, the transceiver 1110 may obtain a signal (e.g., a frequency domain signal) on which CP removal and FFT have been performed for the received signals.

Although not illustrated in FIG. 11A, the transceiver 1110 may further include a backhaul transceiver for connection with a core network or another base station. The backhaul transceiver provides an interface for performing communication with other nodes in the network. In other words, the backhaul transceiver converts a bit string transmitted from a base station to another node, such as another access node, another base station, an upper node, and a core network into a physical signal, and converts a physical signal received from another node into a bit string.

The memory 1120 stores a basic program, an application program, and data such as configuration information for an operation of the DU 210. The memory 1120 may be referred to as a storage unit. The memory 1120 may be configured with a volatile memory, a nonvolatile memory, or a combination of the volatile memory and the nonvolatile memory. In addition, the memory 1120 provides stored data according to a request from the processor 1130.

The processor 1130 may include various processing circuitry and controls overall operations of the DU 210. The processor 1130 may be referred to as a control unit. For example, the processor 1130 transmits and receives a signal through the transceiver 1110 (or through a backhaul communication unit). In addition, the processor 1130 writes and reads data in the memory 1120. In addition, the processor 1130 may perform functions of a protocol stack required in a communication standard. Although only the processor 1130 is illustrated in FIG. 11A, the DU 210 may include two or more processors. Thus, the processor 1130 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. According to an embodiment, the memory 1120 may store inter-symbol correlation information of the present disclosure. For example, the memory 1120 may store first correlation information (e.g., the first correlation information 751). The memory 1120 may store second correlation information (e.g., the second correlation information 752). The memory 1120 may store third correlation information (e.g., the third correlation information 753). The memory 1120 may store fourth correlation information (e.g., the fourth correlation information 754).

According to an embodiment, the processor 1130 may perform the physical layer processing on signals received from the RU (e.g., the RU 220). For example, the processor 1130 may perform subcarrier demapping (RE demapping) on the received signals. For example, the processor 1130 may obtain a noise-interference component (e.g., noise-interference covariance matrix) based on the received reference signals. In addition, for example, the processor 1130 may perform channel estimation based on the received reference signals. The processor 1130 may determine a weight for a reception combiner. The processor 1130 may determine data corresponding to an uplink signal.

A configuration of the DU 210 illustrated in FIG. 11A is merely an example, and the example of the DU performing embodiments of the present disclosure is not limited to the configuration illustrated in FIG. 11A. In various embodiments, certain configurations may be added, deleted, or changed.

FIG. 11B is a block diagram illustrating an example configuration of an RU (e.g., the RU 220) according to various embodiments. A configuration illustrated in FIG. 11B, which is as a part of a base station, may be understood as a configuration of the RU 220 of FIG. 2. Hereinafter, the terms ‘ . . . unit’ and ‘ . . . er’ used below refer to a unit processing at least one function or operation, which may be implemented by hardware or software, or a combination of hardware and software.

Referring to FIG. 11B, the RU 220 includes an RF transceiver 1160, a fronthaul transceiver 1165, memory 1170, and a processor (e.g., including processing circuitry) 1180.

The RF transceiver 1160 performs functions for transmitting and receiving a signal through a wireless channel. For example, the RF transceiver 1160 up-converts a baseband signal into an RF band signal and then transmits it through an antenna, and down-converts an RF band signal received through the antenna into a baseband signal. For example, the RF transceiver 1160 may include a transmission filter, a reception filter, an amplifier, a mixer, an oscillator, a DAC, an ADC.

The RF transceiver 1160 may include a plurality of transmission/reception paths. Furthermore, the RF transceiver 1160 may include an antenna unit. The RF transceiver 1160 may include at least one antenna array composed of a plurality of antenna elements. In terms of hardware, the RF transceiver 1160 may be composed of a digital circuit and an analog circuit (e.g., a radio frequency integrated circuit (RFIC)). Herein, the digital circuit and the analog circuit may be implemented as a single package. In addition, the RF transceiver 1160 may include a plurality of RF chains. The RF transceiver 1160 may perform beamforming. In order to provide directivity to a signal to be transmitted and received according to the setting of the processor 1180, the RF transceiver 1160 may apply beamforming weights to the signal. According to an embodiment, the RF transceiver 1160 may provide a plurality of antennas.

According to an embodiment, the RF transceiver 1160 may transmit and receive a signal on a radio access network. For example, the RF transceiver 1160 may transmit a downlink signal. The downlink signal may include a synchronization signal (SS), a reference signal (RS) (e.g., cell-specific reference signal (CRS), demodulation (DM)-RS), system information (e.g., MIB, SIB, remaining system information (RMSI), other system information (OSI)), configuration message, control information or downlink data. In addition, for example, the RF transceiver 1160 may receive an uplink signal. The uplink signal may include a random access-related signal (e.g., NPRACH, NPUSCH). According to an embodiment, the RF transceiver 1160 may receive signals including a random access signal through a plurality of antennas provided in the RF transceiver 1160. Although only the RF transceiver 1160 is illustrated in FIG. 11B, the RU 220 may include two or more RF transceivers according to another implementation.

The fronthaul transceiver 1165 may transmit and receive a signal. According to an embodiment, the fronthaul transceiver 1165 may transmit and receive a signal on a fronthaul interface. For example, the fronthaul transceiver 1165 may receive a management plane (M-plane) message. For example, the fronthaul transceiver 1165 may receive a synchronization plane (S-plane) message. For example, the fronthaul transceiver 1165 may receive a control plane (C-plane) message. For example, the fronthaul transceiver 1165 may transmit a user plane (U-plane) message. For example, the fronthaul transceiver 1165 may receive a U-plane message. According to an embodiment, the fronthaul transceiver 1165 may transmit a signal (e.g., a frequency domain signal) on which CP removal and FFT have been performed, to the DU (e.g., the DU 210). Although only the fronthaul transceiver 1165 is illustrated in FIG. 11B, the RU 220 may include two or more fronthaul transceivers according to another implementation.

As described above, the RF transceiver 1160 and the fronthaul transceiver 1165 transmit and receive a signal. Accordingly, all or some of the RF transceiver 1160 and the fronthaul transceiver 1165 may be referred to as a ‘communication unit’, a ‘transmission unit’, a ‘reception unit’, or a ‘transmission/reception unit’. In addition, in the following description, transmission and reception performed through a wireless channel are used to the meaning including that the processing as described above is performed by the RF transceiver 1160. In the following description, transmission and reception performed through a wireless channel are used to the meaning including that the processing as described above is performed by the RF transceiver 1160.

The memory 1170 stores a basic program, an application program, and data such as configuration information for an operation of the RU 220. The memory 1170 may be referred to as a storage unit. The memory 1170 may be configured with a volatile memory, a nonvolatile memory, or a combination of the volatile memory and the nonvolatile memory. In addition, the memory 1170 provides stored data according to a request from the processor 1180.

The processor 1180 may include various processing circuitry and controls overall operations of the RU 220. The processor 1180 may be referred to as a control unit. For example, the processor 1180 transmits and receives a signal through the RF transceiver 1160 or the fronthaul transceiver 1165. In addition, the processor 1180 writes and reads data in the memory 1170. In addition, the processor 1180 may perform functions of a protocol stack required by a communication standard. Although only the processor 1180 is illustrated in FIG. 11B, the RU 220 may include two or more processors. The processor 1180, which is an instruction set or code stored in the memory 1170, may be an instruction/code at least temporarily resided in the processor 1180 or a storage space storing instruction/code, or part of circuitry of the processor 1180. In addition, the processor 1180 may include various modules for performing communication. The processor 1180 may control the RU 220 to perform operations according to various example embodiments. Thus, the processor 1180 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

A configuration of the RU 220 illustrated in FIG. 11B is simply an example, and an example of the RU performing various embodiments of the present disclosure is not limited to the configuration illustrated in FIG. 11B. In various embodiment, some configurations may be added, deleted, or changed.

In various example embodiments, a method performed by a device of a base station is provided. The method may comprise obtaining an uplink signal of a data symbol. The method may comprise obtaining a first noise-and-interference covariance matrix for reference signals. The method may comprise obtaining a second noise-and-interference covariance matrix for a reference signal associated with the data symbol among the reference signals. The method may comprise identifying whether a second interference factor of the second noise-and-interference covariance matrix is within an abnormal range based on a first interference factor of the first noise-and-interference covariance matrix. In a case that the second interference factor of the second noise-and-interference covariance matrix is within the abnormal range, the method may comprise obtaining data corresponding to the uplink signal based on the second noise-and-interference covariance matrix. In a case that the second interference factor of the second noise-and-interference covariance matrix is not within the abnormal range, the method may comprise obtaining the data corresponding to the uplink signal based on the first noise-and-interference covariance matrix.

According to an embodiment, the first noise-and-interference covariance matrix for the reference signals may be obtained based on an average of noise-and-interference covariance matrices of the reference signals.

According to an embodiment, the identifying whether the second interference factor is within the abnormal range may comprise determining a type of interference factor. The identifying whether the second interference factor is within the abnormal range may comprise determining the first interference factor of the first noise-and-interference covariance matrix in accordance with the type. The identifying whether the second interference factor is within the abnormal range may comprise determining the second interference factor of the second noise-and-interference covariance matrix in accordance with the type.

According to an embodiment, the type may indicate a whitening factor. The first interference factor may be determined based on a diagonal term of the first noise-and-interference covariance matrix and norm information of the first noise-and-interference covariance matrix. The second interference factor may be determined based on a diagonal term of the second noise-and-interference covariance matrix and norm information of the second noise-and-interference covariance matrix.

According to an embodiment, the type may indicate oracle approximating shrinkage (OAS). The first interference factor may be determined based on the number of reception antennas at the base station, the number of samples, the diagonal term of the first noise-and-interference covariance matrix, and the norm information of the first noise-and-interference covariance matrix. The second interference factor may be determined based on the number of reception antennas at the base station, the number of samples, the diagonal term of the second noise-and-interference covariance matrix, and the norm information of the second noise-and-interference covariance matrix.

According to an embodiment, the type may indicate trace. The first interference factor may be a sum of real values of the diagonal term of the first noise-and-interference covariance matrix. The second interference factor may be a sum of real values of the diagonal term of the second noise-and-interference covariance matrix.

According to an embodiment, the identifying whether the second interference factor is within the abnormal range may include identifying whether a difference between the first interference factor and the second interference factor is greater than a threshold. In a case that the difference is greater than the threshold, the second interference factor may be within the abnormal range. In a case that the difference is not greater than the threshold, the second interference factor may not be within the abnormal range.

According to an embodiment, the identifying whether the second interference factor is within the abnormal range may include identifying whether a ratio of the first interference factor to the second interference factor is greater than a first threshold or less than a second threshold. In a case that the ratio is greater than the first threshold or less than the second threshold, the second interference factor may be within the abnormal range. In a case that the ratio is less than or equal to the first threshold and greater than or equal to the second threshold, the second interference factor may not be within the abnormal range.

According to an embodiment, the reference signal associated with the data symbol may be mapped to a position most adjacent to the data symbol among symbols to which the reference signals are mapped.

According to an embodiment, the reference signals may include demodulation reference signals (DMRSs). The data may include a physical uplink shared channel (PUSCH) transmission.

In various example embodiments, a device of a base station is provided. The device may comprise memory, at least one transceiver, and at least one processor, comprising processing circuitry. At least one processor, individually and/or collectively, may be configured to cause the electronic device to: obtain an uplink signal of a data symbol; obtain a first noise-and-interference covariance matrix for reference signals; obtain a second noise-and-interference covariance matrix for a reference signal associated with the data symbol among the reference signals; identify whether a second interference factor of the second noise-and-interference covariance matrix is within an abnormal range based on a first interference factor of the first noise-and-interference covariance matrix; obtain data corresponding to the uplink signal based on the second noise-and-interference covariance matrix based on the second interference factor of the second noise-and-interference covariance matrix being within the abnormal; and obtain the data corresponding to the uplink signal based on the first noise-and-interference covariance matrix based on the second interference factor of the second noise-and-interference covariance matrix not being within the abnormal range.

According to an embodiment, the first noise-and-interference covariance matrix for the reference signals may be obtained based on an average of noise-and-interference covariance matrices of the reference signals.

According to an embodiment, to identify (obtain) whether the second interference factor is within the abnormal range, the at least one processor may be configured to determine a type of interference factor. To identify whether the second interference factor is within the abnormal range, the at least one processor may be configured to determine the first interference factor of the first noise-and-interference covariance matrix in accordance with the type. To identify whether the second interference factor is within the abnormal range, the at least one processor may be configured to determine the second interference factor of the second noise-and-interference covariance matrix in accordance with the type.

According to an embodiment, the type may indicate a whitening factor. The first interference factor may be determined based on a diagonal term of the first noise-and-interference covariance matrix and norm information of the first noise-and-interference covariance matrix. The second interference factor may be determined based on a diagonal term of the second noise-and-interference covariance matrix and norm information of the second noise-and-interference covariance matrix.

According to an embodiment, the type may indicate oracle approximating shrinkage (OAS). The first interference factor may be determined based on the number of reception antennas at the base station, the number of samples, the diagonal term of the first noise-and-interference covariance matrix, and the norm information of the first noise-and-interference covariance matrix. The second interference factor may be determined based on the number of reception antennas at the base station, the number of samples, the diagonal term of the second noise-and-interference covariance matrix, and the norm information of the second noise-and-interference covariance matrix.

According to an embodiment, the type may indicate trace. The first interference factor may be a sum of real values of the diagonal term of the first noise-and-interference covariance matrix. The second interference factor may be a sum of real values of the diagonal term of the second noise-and-interference covariance matrix.

According to an embodiment, to identify whether the second interference factor is within the abnormal range, the at least one processor may be configured to identify whether a difference between the first interference factor and the second interference factor is greater than a threshold. In a case that the difference is greater than the threshold, the second interference factor may be within the abnormal range. In a case that the difference is not greater than the threshold, the second interference factor may be within the abnormal range.

According to an embodiment, to identify whether the second interference factor is within the abnormal range, the at least one processor may be configured to identify whether a ratio of the first interference factor to the second interference factor is greater than a first threshold or less than a second threshold. In a case that the ratio is greater than the first threshold or less than the second threshold, the second interference factor may be within the abnormal range. In a case that the ratio is less than or equal to the first threshold and greater than or equal to the second threshold, the second interference factor may not be within the abnormal range.

According to an embodiment, the reference signal associated with the data symbol may be mapped to a position most adjacent to the data symbol among symbols to which the reference signals are mapped.

According to an embodiment, the reference signals may include demodulation reference signals (DMRSs). The data may include a physical uplink shared channel (PUSCH) transmission.

In various example embodiments, a digital unit (DU) is provided in a wireless communication system. The DU may comprise memory storing instructions, at least one transceiver, and at least one processor comprising processing circuitry, wherein at least one processor, individually and/or collectively, may be configured to execute the instructions and to cause the DU to: obtain an uplink signal of a data symbol, obtain a first noise-and-interference covariance matrix for reference signals, obtain a second noise-and-interference covariance matrix for a reference signal associated with the data symbol among the reference signals, identify whether a second interference factor of the second noise-and-interference covariance matrix is within an abnormal range based on a first interference factor of the first noise-and-interference covariance matrix, obtain data corresponding to the uplink signal based on the second noise-and-interference covariance matrix based on the second interference factor of the second noise-and-interference covariance matrix being within the abnormal range, and obtain the data corresponding to the uplink signal based on the first noise-and-interference covariance matrix based on the second interference factor of the second noise-and-interference covariance matrix not being within the abnormal range.

According to an embodiment, the instructions, when executed by the at least one processor, may cause the DU to identify whether the second interference factor is within the abnormal range by determining a type of interference factor, determining the first interference factor of the first noise interference covariance matrix in accordance with the type, and determining the second interference factor of the second noise interference covariance matrix in accordance with the type.

According to an embodiment, the instructions, when executed by the at least one processor, may cause the DU to identify whether the second interference factor is within the abnormal range by identifying whether a difference between the first interference factor and the second interference factor is greater than a threshold, the second interference factor may be within the abnormal range in a case that the difference is greater than the threshold, and the second interference factor may not be within the abnormal range in a case that the difference is not greater than the threshold.

According to an embodiment, the instructions, when executed by the at least one processor, may cause the DU to identify whether the second interference factor is within the abnormal range by identifying whether a ratio of the first interference factor to the second interference factor is greater than a first threshold or less than a second threshold, the second interference factor may be within the abnormal range in a case that the ratio is greater than the first threshold or less than the second threshold, and the second interference factor may not be within the abnormal range in a case that the ratio is less than or equal to the first threshold and greater than or equal to the second threshold.

In embodiments, a radio unit (RU) is provided in a wireless communication system. The RU may comprise memory storing instructions, at least one transceiver, and at least one processor, the instructions, when executed by the at least one processor, may cause the RU to obtain an uplink signal of a data symbol, obtain a first noise-and-interference covariance matrix for reference signals, obtain a second noise-and-interference covariance matrix for a reference signal associated with the data symbol among the reference signals, identify whether a second interference factor of the second noise-and-interference covariance matrix is within an abnormal range based on a first interference factor of the first noise-and-interference covariance matrix, obtain data corresponding to the uplink signal based on the second noise-and-interference covariance matrix in a case that the second interference factor of the second noise-and-interference covariance matrix is within the abnormal range, and obtain the data corresponding to the uplink signal based on the first noise-and-interference covariance matrix in a case that the second interference factor of the second noise-and-interference covariance matrix is not within the abnormal range.

In embodiments, a non-transitory computer-readable storage medium is provided. The non-transitory computer readable storage medium may store instructions that, when executed by a processor of a device, cause the device to perform operations including obtaining an uplink signal of a data symbol, obtaining a first noise-and-interference covariance matrix for reference signals, obtaining a second noise-and-interference covariance matrix for a reference signal associated with the data symbol among the reference signals, identifying whether a second interference factor of the second noise-and-interference covariance matrix is within an abnormal range based on a first interference factor of the first noise-and-interference covariance matrix, obtaining data corresponding to the uplink signal based on the second noise-and-interference covariance matrix in a case that the second interference factor of the second noise-and-interference covariance matrix is within the abnormal range, and obtaining the data corresponding to the uplink signal based on the first noise-and-interference covariance matrix in a case that the second interference factor of the second noise-and-interference covariance matrix is not within the abnormal range.

Embodiments of the present disclosure may provide a technique for enhancing reception performance by adaptively performing an average operation other than uniformly performing it, to reflect a noise component and an interference component within a slot. In receiving an uplink signal, the reception performance may be improved by selecting an appropriate noise-and-interference covariance matrix to accurately reflect noise and interference characteristics of a channel. In addition, reception performance of a receiver may be further improved by determining a more suitable interference factor in accordance with a channel state.

The effects that can be obtained from the present disclosure are not limited to those described above, and any other effects not mentioned herein will be clearly understood by those having ordinary knowledge in the art to which the present disclosure belongs.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software including one or more instructions that are stored in a storage medium that is readable by a machine. For example, a processor of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between a case in which data is semi-permanently stored in the storage medium and a case in which the data is temporarily stored in the storage medium.

Methods according to various embodiments of the present disclosure may be implemented as a form of hardware, software, or a combination of hardware and software.

In a case of implementing as software, a computer-readable storage medium for storing one or more programs (software module) may be provided. The one or more programs stored in the computer-readable storage medium are configured for execution by one or more processors in an electronic device. The one or more programs include instructions that cause the electronic device to execute the methods according to various embodiments of the present disclosure. The one or more programs may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. In the case of being distributed online, at least part of the computer program product may be temporarily generated or at least temporarily stored in the machine-readable storage medium, such as memory of the manufacturer's server, the application store's server, or a relay server.

Such a program (software module, software) may be stored in a random access memory, a non-volatile memory including a flash memory, a read only memory (ROM), an electrically erasable programmable read only memory (EEPROM), a magnetic disc storage device, a compact disc-ROM (CD-ROM), an optical storage device (digital versatile discs (DVDs) or other formats), or a magnetic cassette. Alternatively, it may be stored in memory configured with a combination of some or all of them. In addition, a plurality of configuration memories may be included.

Additionally, a program may be stored in an attachable storage device that may be accessed through a communication network such as the Internet, Intranet, local area network (LAN), wide area network (WAN), or storage area network (SAN), or a combination thereof. Such a storage device may be connected to a device performing an embodiment of the present disclosure through an external port. In addition, a separate storage device on the communication network may also be connected to a device performing an embodiment of the present disclosure.

In the above-described example embodiments of the present disclosure, components included in the disclosure are expressed in the singular or plural according to the various embodiments. However, the singular or plural expression is selected appropriately according to a situation presented for convenience of explanation, and the present disclosure is not limited to the singular or plural component, and even components expressed in the plural may be configured in the singular, or a component expressed in the singular may be configured in the plural.

According to various embodiments, one or more components or operations of the above-described components may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be executed sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device configured to perform functions of a digital unit (DU) in a wireless communication system, the DU comprising:
memory storing instructions;
at least one transceiver; and
at least one processor, comprising processing circuitry;
wherein at least one processor, individually and/or collectively, is configured to execute the instructions and to cause the DU to:
obtain an uplink signal of a data symbol;
obtain a first noise-and-interference covariance matrix for reference signals;
obtain a second noise-and-interference covariance matrix for a reference signal associated with the data symbol among the reference signals;
identify whether a second interference factor of the second noise-and-interference covariance matrix is within an abnormal range based on a first interference factor of the first noise-and-interference covariance matrix;
based on the second interference factor of the second noise-and-interference covariance matrix being within the abnormal range, obtain data corresponding to the uplink signal based on the second noise-and-interference covariance matrix; and
based on the second interference factor of the second noise-and-interference covariance matrix not being within the abnormal range, obtain the data corresponding to the uplink signal based on the first noise-and-interference covariance matrix.

2. The electronic device of claim 1,
wherein the first noise-and-interference covariance matrix for the reference signals is obtained based on an average of noise-and-interference covariance matrices of the reference signals.

3. The electronic device of claim 1,
wherein the instructions, when executed by the at least one processor individually and/or collectively, cause the DU to identify whether the second interference factor is within the abnormal range by:
determining a type of interference factor;
determining the first interference factor of the first noise-and-interference covariance matrix in accordance with the type; and
determining the second interference factor of the second noise-and-interference covariance matrix in accordance with the type.

4. The electronic device of claim 3,
wherein the type indicates a whitening factor,
wherein the first interference factor is determined based on a diagonal term of the first noise-and-interference covariance matrix and norm information of the first noise-and-interference covariance matrix, and
wherein the second interference factor is determined based on a diagonal term of the second noise-and-interference covariance matrix and norm information of the second noise-and-interference covariance matrix.

5. The electronic device of claim 3,
wherein the type indicates oracle approximating shrinkage (OAS),
wherein the first interference factor is determined based on the number of reception antennas at a base station, the number of samples, the diagonal term of the first noise-and-interference covariance matrix, and the norm information of the first noise-and-interference covariance matrix, and
wherein the second interference factor is determined based on the number of reception antennas at the base station, the number of samples, the diagonal term of the second noise-and-interference covariance matrix, and the norm information of the second noise-and-interference covariance matrix.

6. The electronic device of claim 3,
wherein the type indicates trace,
wherein the first interference factor includes a sum of real values of the diagonal term of the first noise-and-interference covariance matrix, and
wherein the second interference factor includes a sum of real values of the diagonal term of the second noise-and-interference covariance matrix.

7. The electronic device of claim 1,
wherein at least one processor, individually and/or collectively, is configured to cause the DU to identify whether the second interference factor is within the abnormal range by identifying whether a difference between the first interference factor and the second interference factor is greater than a threshold,
wherein, based on the difference being greater than the threshold, the second interference factor is within the abnormal range, and
wherein, based on the difference not being greater than the threshold, the second interference factor is not within the abnormal range.

8. The electronic device of claim 1,
wherein at least one processor, individually and/or collectively, is configured to cause the DU to identify whether the second interference factor is within the abnormal range by identifying whether a ratio of the first interference factor to the second interference factor is greater than a first threshold or less than a second threshold,
wherein, based on the ratio being greater than the first threshold or less than the second threshold, the second interference factor is within the abnormal range, and
wherein, based on the ratio being less than or equal to the first threshold and greater than or equal to the second threshold, the second interference factor is not within the abnormal range.

9. The electronic device of claim 1,
wherein the reference signal associated with the data symbol is mapped to a position most adjacent to the data symbol among symbols to which the reference signals are mapped.

10. The electronic device of claim 1,
wherein the reference signals include demodulation reference signals (DMRSs), and
wherein the data includes a physical uplink shared channel (PUSCH) transmission.

11. A method performed by a device of a base station, the method comprising:
obtaining an uplink signal of a data symbol;
obtaining a first noise-and-interference covariance matrix for reference signals;
obtaining a second noise-and-interference covariance matrix for a reference signal associated with the data symbol among the reference signals;
identifying whether a second interference factor of the second noise-and-interference covariance matrix is within an abnormal range based on a first interference factor of the first noise-and-interference covariance matrix;
based on the second interference factor of the second noise-and-interference covariance matrix being within the abnormal range, obtaining data corresponding to the uplink signal based on the second noise-and-interference covariance matrix; and
based on the second interference factor of the second noise-and-interference covariance matrix not being within the abnormal range, obtaining the data corresponding to the uplink signal based on the first noise-and-interference covariance matrix.

12. The method of claim 11,
wherein the first noise-and-interference covariance matrix for the reference signals is obtained based on an average of noise-and-interference covariance matrices of the reference signals.

13. The method of claim 11,
wherein the identifying whether the second interference factor is within the abnormal range comprises:
determining a type of interference factor;
determining the first interference factor of the first noise-and-interference covariance matrix in accordance with the type; and
determining the second interference factor of the second noise-and-interference covariance matrix in accordance with the type.

14. An electronic device configured to perform functions of a radio unit (RU) in a wireless communication system, the RU comprising:
memory storing instructions;
at least one transceiver; and
at least one processor, comprising processing circuitry;
wherein at least one processor, individually and/or collectively, is configured to execute the instructions and to cause the RU to:
obtain an uplink signal of a data symbol;
obtain a first noise-and-interference covariance matrix for reference signals;
obtain a second noise-and-interference covariance matrix for a reference signal associated with the data symbol among the reference signals;
identify whether a second interference factor of the second noise-and-interference covariance matrix is within an abnormal range based on a first interference factor of the first noise-and-interference covariance matrix;
based on the second interference factor of the second noise-and-interference covariance matrix being within the abnormal range, obtain data corresponding to the uplink signal based on the second noise-and-interference covariance matrix; and
based on the second interference factor of the second noise-and-interference covariance matrix not being within the abnormal range, obtain the data corresponding to the uplink signal based on the first noise-and-interference covariance matrix.

15. A non-transitory computer-readable storage medium storing instructions that, when executed by at least one processor, comprising processing circuitry, individually and/or collectively, of a device, cause the device to perform operations including:
obtaining an uplink signal of a data symbol;
obtaining a first noise-and-interference covariance matrix for reference signals;
obtaining a second noise-and-interference covariance matrix for a reference signal associated with the data symbol among the reference signals;
identifying whether a second interference factor of the second noise-and-interference covariance matrix is within an abnormal range based on a first interference factor of the first noise-and-interference covariance matrix;
based on the second interference factor of the second noise-and-interference covariance matrix being within the abnormal range, obtaining data corresponding to the uplink signal based on the second noise-and-interference covariance matrix; and
based on the second interference factor of the second noise-and-interference covariance matrix not being within the abnormal range, obtaining the data corresponding to the uplink signal based on the first noise-and-interference covariance matrix.
